(19) United States
(12) Patent Application Publication
(10) Pub. No.: US 2026/0002410 A1
(43) Pub. Date: Jan. 1, 2026

(54) Motorized Window Covering Systems And Methods Using A Weather Based Application Programming Interface (API)

(71) Applicant: Lutron Technology Company LLC, Coopersburg, PA (US)

(72) Inventors: Brent Protzman, Easton, PA (US); Craig Alan Casey, Coopersburg, PA (US); Yogesh Venkata Gopalan, Cambridge, MA (US)

(73) Assignee: Lutron Technology Company LLC, Coopersburg, PA (US)

(21) Appl. No.: 19/071,021

(22) Filed: Mar. 5, 2025

Related U.S. Application Data
(60) Provisional application No. 63/561,474, filed on Mar. 5, 2024.

(51) Int. Cl. E06B 9/322; E06B 9/68

(52) U.S. Cl. CPC E06B 9/322; E06B 9/68; E06B 2009/6863

(57) ABSTRACT

The present disclosure is directed to the autonomous positioning of motorized window coverings to provide a desired level of illumination in the interior space of a structure. Control circuitry determines a base position and/or a base angle of rotation/tilt using data representative of the geolocation and compass heading of the motorized window covering, the calendar date, and the time of day. Using a weather data API, the control circuitry receives data representative of current local weather and/or current predicted short-term local weather. The control circuitry determines a final position and/or a final angle of rotation/tilt to provide the desired level of illumination in the interior space of the structure using the geolocation and compass heading of the motorized window covering, the calendar date, the time of day, and the received weather data.

### BACKGROUND

Window treatments typically include a flexible fabric, blind slats, or other means for covering a window to block or limit the daylight entering a space and to provide privacy. The window treatments may include roller shades, cellular shades, Roman shades, Venetian blinds, and draperies. Venetian or horizontal blinds may have mechanisms to raise/lower and tilt the slats. Typically, the slats on a venetian blind are rotatable through an arc of approximately 180°. Mechanisms to position a shade or blind at a desired height or elevation may be mechanized such that a drive motor or similar device raises and lowers the shade or blind upon receipt of an automatically or manually generated command to change the position of the shade or blind, such mechanisms to change the position of shades or blinds may be generally or generically referred to as “motorized window coverings.” In addition to providing the ability to raise and lower a window treatment, one or more mechanisms may also be used to rotate or tilt the slats in a venetian blind through some or all the 180° arc of movement. Beneficially, based on the angle of the light incident on the exterior surface of a venetian blind, the slats may be rotated or tilted to an angle where a majority (or almost all) of the light incident on the venetian blind is reflected from or absorbed by the blind, thereby reducing the level of illumination in the space, zone, or room in which the venetian blind is installed. Conversely, venetian blind slats may be rotated or tilted to an angle that approximately matches the incident angle of the light falling on the exterior surface of the slats thereby permitting a majority (or almost all) of the light incident on the venetian blind to pass through the blind, thereby increasing the level of illumination in the space, zone, or room in which the venetian blind is installed. tilt the slats may result in openings in the slats that are visible when the blinds are closed, which may reduce privacy and allow unwanted light to penetrate the room.

### SUMMARY

A motorized window covering controller is provided as one or more embodiments. The motorized window covering controller may include: control circuitry to: execute a weather data application programming interface (API) to transfer local weather-related data from a weather data provider; receive at least one input that includes data representative of a desired level of illumination within a space; receive, via the API, the transferred local weather data from the weather data provider; and determine at least one of: a final position and a final angle of rotation of at least one motorized window covering to provide the desired level of illumination within the space using the received local weather-related data.

A motorized window covering control method is provided as one or more embodiments. The method may include: executing, by control circuitry, a weather data application programming interface (API) to transfer local weather-related data from a weather data provider; receiving, by the control circuitry, at least one input that includes data representative of a desired level of illumination within a space; receiving, by the control circuitry, the local weather-related data from the weather data provider via the API; and determining, by the control circuitry, at least one of: a final position and a final angle of rotation of at least one motorized window covering to provide the desired level of illumination within the space using the received local weather-related data.

A non-transitory, machine-readable, storage device that includes machine-readable instructions is provided as one or more embodiments. In such embodiments, the machine-readable instructions, when executed by motorized window covering control circuitry, may cause the control circuitry to: execute a weather data application programming interface (API) to transfer local weather-related data from a weather data provider; receive at least one input that includes data representative of a desired level of illumination within a space; receive the local weather-related data from the weather data provider via the API; and determine at least one of: a final position and a final angle of rotation of at least one motorized window covering to provide the desired level of illumination within the space using the received local weather-related data.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 depicts a block diagram of a motorized window covering control system that includes a motorized window covering disposed proximate a window in a space, a control circuitry executes an application programming interface (“API”) that, via communications interface circuitry, receives local current or short-term weather forecast data from one or more weather data providers, in accordance with one or more embodiments described herein;

FIG. 2 is a schematic diagram of another illustrative system that includes a roller shade motorized window covering in which the headrail incorporates at least a portion of the control circuitry, in accordance with one or more embodiments described herein;

FIG. 3 is a schematic diagram of an illustrative system that includes a plurality of motorized window coverings, each communicatively coupled via a first network to system control circuitry capable of executing the weather data API to receive weather-related information from the weather data provider via a second network, in accordance with one or more embodiments described herein;

FIG. 4 depicts a plan view of an illustrative system in which system control circuitry 310 autonomously adjusts the position and/or angle of rotation/tilt of a plurality of motorized window coverings disposed on the north, the south, the east, and the west compass headings of a structure, using location, compass heading, date, time-of-day, and local weather data, in accordance with one or more embodiments described herein;

FIG. 5 is a perspective view of an illustrative Venetian blind motorized window covering that includes a headrail, a plurality of slats, a positioning driver that raises and lowers the slats, a rotation/tilt drive that tilts the slats at any angle between 0° (vertically outward), 90°(horizontal), and 180° (vertically inward), in accordance with one or more embodiments described herein;

FIG. 6 is a block diagram of an illustrative system that includes a Venetian blind motorized window covering headrail communicatively coupled to a weather data provider via one or more second networks, in accordance with one or more embodiments described herein;

FIG. 7 is a block diagram of an illustrative system in which system controller circuitry alters, adjusts, moves, or controls the position and the angle of rotation/tilt of a plurality of Venetian blind motorized window coverings, in accordance with one or more embodiments described herein;

FIG. 8 depicts an input/output diagram of illustrative control circuitry that includes a plurality of inputs and a plurality of outputs, in accordance with one or more embodiments described herein;

FIG. 9 is a high-level logic flow diagram of an illustrative method of determining a final position and/or a final angle of rotation/tilt for one or more motorized window coverings based on the location, the compass heading, the date, the time-of-day, and the local weather conditions proximate each of the motorized window coverings, in accordance with one or more embodiments described herein;

FIG. 10 depicts an illustrative system that includes a motorized window covering having control circuitry that receives weather related information from one or more sources that include one or more local sensors and/or via API from a weather data provider, in accordance with one or more embodiments described herein;

FIG. 11 depicts an input/output diagram of yet another illustrative control circuitry that includes a plurality of inputs and a plurality of outputs, in accordance with one or more embodiments described herein; and

FIG. 12 is a high-level logic flow diagram of an illustrative method of determining a final position and/or a final angle of rotation/tilt for one or more motorized window coverings based on the location, the compass heading, the date, the time-of-day, and a short-term local weather prediction proximate each of the motorized window coverings, in accordance with one or more embodiments described herein.

Although the following Detailed Description will proceed with reference being made to illustrative embodiments, many alternatives, modifications and variations thereof will be apparent to those skilled in the art.

### DETAILED DESCRIPTION

The systems and methods disclosed herein beneficially and advantageously provide the capability to position a motorized window covering using data representative of the current local weather data and/or predicted local weather data obtained via an application programming interface (API) from an external weather data source, such as a cloud-based or Internet weather source. The use of such weather data in facilitating the proactive positioning of motorized window coverings beneficially provides a significant improvement in both performance and aesthetics over reactive motorized window covering positioning systems using one or more of: geolocation, date, and/or time-of-day. In addition, the use of such weather data to proactively position motorized window coverings beneficially provides greater uniformity and reduced variability in lighting levels thereby improving ergonomics over-reactive, sensor-based, motorized window covering systems.

A motorized window covering such as a shade includes a motor to position the shade at any position from 0% open (i.e., shade at lowest position and window substantially covered) to 100% open (i.e., shade at highest position and window substantially uncovered). Shades typically include a weighted hem bar to “pull” the shade downward. A motorized window covering such as a blind includes a motor to position the bottom bar or slats at any height or position from 0% open (i.e., blind at lowest position where slats can substantially cover the window) to 100% open (i.e., blind at highest position and where the slats do not substantially cover the window). In addition, the slats may be autonomously tilted or rotated through at least a portion of the 180° arc of motion to control, alter, or adjust the light passing through the blind into the space, zone, or room in which the blind is installed. The systems and methods disclosed herein beneficially and advantageously position both the height of a motorized window covering and the slat tilt angle of venetian blinds based on received data indicative of the current local weather and/or received data indicative of the short term local weather forecast.

Local weather data is available from a variety of sources such as publicly accessible online sources such as The Weather Channel (www.weather.com) and private sources such as AcroPlus® (provided by Iridium Corp.) and The Weather Company (provided by IBM Corp.). Such weather data is generated and accessible via either or both the world-wide web (i.e., the Internet) or one or more private networks. Such digital weather data is often accessed using an application programming interface, or “API,” that facilitates and organizes the transfer of data from the weather data provider to the recipient application. The systems and methods disclosed herein make use of this weather information to accurately and proactively position motorized window coverings using data representative of the current local weather and/or data representative of the current local weather and/or the predicted short-term (i.e., within the next 12-24 hours) local weather.

Control circuitry disposed either locally proximate a motorized window covering or a system control circuitry disposed remote from, but communicatively coupled to a motorized window covering control circuitry may execute an application programming interface (API) that receives data representative of the current local weather and/or data representative of the local near-term weather forecast from a weather data source, such as a Website or private weather data provider. Such local control circuitry and remote-control circuitry may be referred to simply as “control circuitry” capable of altering, adjusting, moving, or otherwise controlling one or more operational aspects of one or more motorized window coverings. At times, weather related data may be pulled by the control circuitry, via a weather data API executed by the control circuitry, from the weather data provider on a regular, irregular, periodic, aperiodic, intermittent, or continuous basis. At other times, such weather data may be pushed by the weather data provider to the control circuitry on a regular, irregular, periodic, aperiodic, intermittent, or continuous basis.

The control circuitry is communicatively coupled to one or more communication interface circuits and one or more memory circuits. The one or more memory circuits may store or otherwise retain data representative of an expected level of direct (e.g., sunlight) or indirect (e.g., reflected sunlight) illumination as a function of orientation, geolocation, date, and time-of-day. Additionally, or alternatively, the control circuitry may execute one or more algorithms to determine the expected level of direct and/or indirect illumination. Using the retrieved or calculated data representative of the expected illumination in combination with the received data representative of the current local weather and/or data representative of the local near-term weather, the control circuitry determines the position of one or more motorized shades and/or the position and rotation/tilt angle of the slats of a motorized blind to achieve a desired illumination level in an interior zone, space, or room. In addition to the date, time-of-day, and local weather conditions, the desired illumination level may be determined based upon the occupancy of the space, the use of the space, existing illumination level (e.g., a light sensor providing an indication of the illumination provided by lamps or similar light fixtures located in the space), or combinations thereof.

In operation, the control circuitry executes an API on a periodic, aperiodic, intermittent, or continuous basis. Weather data received by the API may include data representative of weather-related values such as temperature, humidity, wind speed, wind direction, precipitation, cloud cover, and similar. The control circuitry may execute one or more applications that position the one or more motorized window coverings based on the location, compass heading, date, and time-of-day in the absence of weather data. Upon receipt of the weather data, the control circuitry may alter, adjust, or change the position and/or the rotation/tilt of one or more motorized window coverings based on the impact of the expected weather on the availability of exterior ambient light. For example, a control circuitry may position the rotation/tilt of the slats of a motorized blind at 45° to reflect a portion of the ambient light incident on the motorized blind to maintain a desired level of illumination within an interior space. Responsive to receipt of weather data indicative of an overcast day with expected precipitation (i.e., an overall reduction of available ambient exterior light as compared to a clear, bright, sunny day as determined using location, orientation, date, and time-of-day), the control circuitry may rotate/tilt the slats of the motorized blind to 90° to increase the amount of ambient exterior light passing through the blind.

The control circuitry, and consequently execution of the API, may be disposed proximate the motorized window covering, for example in the valance or headrail of the motorized window covering. In such instances, the control circuitry may execute one or more applications, algorithms, programs, logic flows, or similar to determine a position and/or rotation/tilt for the motorized window covering. In some instances, the control circuitry may wirelessly or wiredly communicate data representative of the determined position and/or rotation/tilt of the motorized window covering to one or more additional motorized window coverings, such as one or more additional motorized window coverings disposed on the same façade of the building as the control circuitry. Such communications may be accomplished via one or more networks, such as one or more mesh networks, one or more TCP/IP networks, or similar that communicatively couple the motorized window coverings. In other implementations, the control circuitry may communicate the weather-related data to control circuits, each executing one or more applications, algorithms, programs, logic flows, or similar to determine a position and/or rotation/tilt for the motorized window covering in each of some or all of the networked motorized window coverings.

The control circuitry may be disposed in whole or in part in a system controller that is disposed remote from the motorized window covering. In such instances, the system controller may be coupled to a plurality of motorized window coverings via one or more local area networks, wide area networks, metropolitan area networks, wireless local area networks, or combinations thereof. In such instances, the system controller may execute one or more applications, algorithms, programs, logic flows, or similar to determine a position and/or rotation/tilt for each of the plurality of motorized window coverings included in the network.

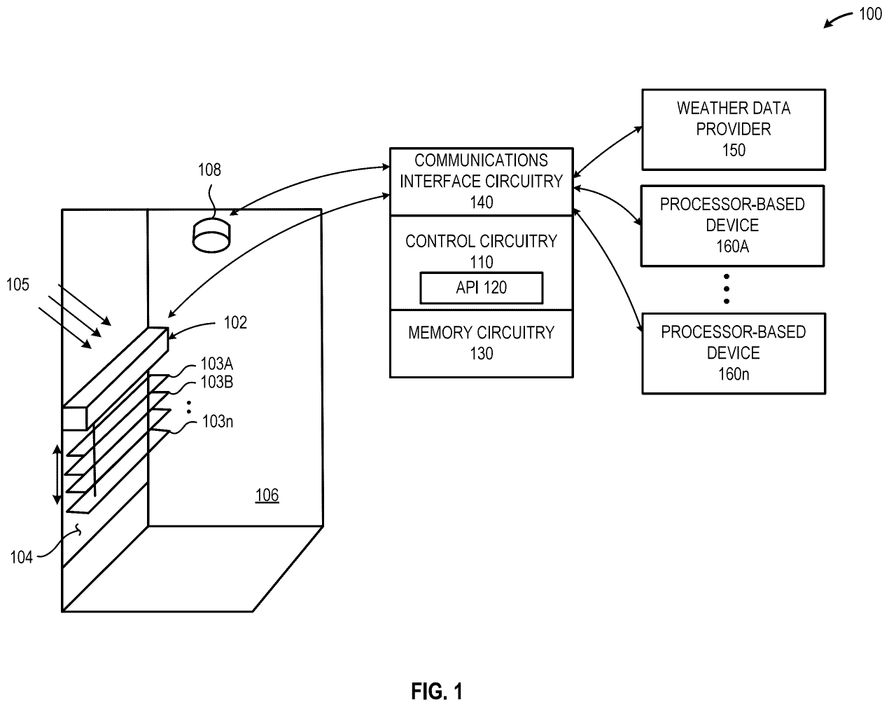

FIG. 1 depicts a block diagram of a motorized window covering control system 100 that includes a motorized window covering 102 disposed proximate a window 104 in a space 106, a control circuitry 110 executes an application programming interface (“API”) 120 that, via communications interface circuitry 140, receives local current or short-term weather forecast data from one or more weather data providers 150, in accordance with one or more embodiments described herein. As depicted in FIG. 1, the motorized window covering 102 may, in some embodiments, include a blind having a plurality of rotatable or tiltable slats. In other embodiments, the motorized window covering 102 may additionally, or alternatively, include other motorized window coverings 102, such as roller shades, cellular shades, Roman shades, Venetian blinds, draperies, and/or combinations thereof. The control circuitry 110 may position the motorized window covering 102 to achieve or provide a desired brightness within the space 106. As depicted in FIG. 1, the control circuitry 110 may adjust the position (e.g., by raising or lowering) the motorized window covering 102 and/or adjust the rotation or tilt of the slats 103A-103n (collectively, “slats 103”) to alter, change, or control the quantity of ambient exterior light 105 entering the space 106 via the window 104.

In operation, the control circuitry 110 positions the motorized window covering 102 to provide a desired level of illumination in the space 106. In at least some embodiments, the control circuitry 110 autonomously alters, adjusts, or changes the position and/or rotation/tilt of the motorized window covering 102 based upon one or more of: the geolocation of the space 106, the compass heading of the window 104, the angle of solar illumination incident on the window 104, the date or solar date, and/or the time-of-day or solar time-of-day to provide the desired level of illumination in the space 106. Although the geolocation, compass heading, date, and time-of-day information may provide an indication of the quantity and direction of natural light incident upon the window 104, such information is unable to reflect the variability and dependency of such illumination on atmospheric occurrences such as the presence of cloud cover, excessive humidity, and/or precipitation. For example, if the local weather related data indicates the presence of cloud cover sufficient to reduce ambient light levels by y percent, the algorithms executed by the control circuitry 110 will increase the ambient light transmitted by the motorized window covering 102 by y percent to maintain a substantially similar level of illumination in the interior space 106. In another example, if the local weather related data indicates the presence of excessive humidity sufficient to cause fog which reduces ambient light levels by z percent, the algorithms executed by the control circuitry 110 will increase the ambient light transmitted by the motorized window covering 102 by z percent to maintain a substantially similar level of illumination in the interior space 106.

The systems and methods disclosed herein beneficially provide such weather-related data to the control circuitry 110 from a communicatively coupled weather data provider 150 via the communication interface circuitry 140. Thus, using the systems and methods disclosed herein, the control circuitry 110 may execute one or more algorithms to autonomously alter, adjust, or change the position and/or rotation/tilt of the motorized window covering 102 based on current or short-term forecasted local weather conditions, such as expected cloud cover and/or precipitation. As used herein, the term “short-term forecasted local weather conditions” refers to future predicted weather conditions over a defined interval of time, for example future weather predicted: over the next 10 minute interval; over the next 30 minute interval; over the next 60 minute interval; over the next 2 hour interval; over the next 4 hour interval; or over the next 8 hour interval. Also, as used herein, “short-term forecasted local weather conditions” refers to predicted weather conditions over variable, random, and/or aperiodic intervals. “Short-term forecasted local weather conditions” The “short-term forecasted local weather conditions” may include user-adjustable intervals or non-adjustable user intervals. Advantageously, the use of such short-term weather prediction data permits the proactive alteration or adjustment of the motorized window covering 102 in anticipation of an imminent, forecasted, or predicted increase/decrease in cloud cover and/or an imminent, forecasted, or predicted commencement/cessation of precipitation or fog. Such proactive control of the motorized window covering 102 represents a significant improvement over systems and methods that position the motorized window covering 102 using only location, compass heading, date, and/or time-of-day information.

Although the control circuitry 110 as depicted in FIG. 1 communicatively couples to only a single motorized window covering 102, in other embodiments, the control circuitry 110 may communicatively couple to a plurality of motorized window coverings 102A-102n. For example, in some embodiments, the control circuitry 110 may communicatively couple to and alter, adjust, and/or change the position and/or rotation/tilt of some or all of the motorized window coverings 102A-102n disposed on a façade of a structure based on the geolocation of the structure and the compass heading of the façade.

The motorized window covering 102 may include any number and/or combination of systems and/or devices capable of incrementally or continuously controlling the admission of external light 105 into the space 106. Although the motorized window covering 102 is depicted in FIG. 1 as a Venetian blind, the motorized window covering 102 may, include other types of window coverings such as roller shades, cellular shades, Roman shades, draperies, and/or combinations thereof. In embodiments, the motorized window covering 102 may include one or more electrochromic and/or liquid crystal coatings (smart glass, switchable privacy glass, etc.) disposed on, about, across, or proximate all or a portion of the surface of the window 104. In embodiments such as depicted in FIG. 1, the control circuitry 110 may execute one or more applications, programs, and/or logic sequences to position a Venetian blind motorized window covering 102 at height ranging from about 0% (i.e., blind lowered to lowest position to provide maximum window coverage) to about 100% (i.e., blind raised to highest position to provide minimum window coverage) based on the geolocation, compass heading, date, time-of-day, and weather data received via the weather data API 120. As used herein, the term “Venetian blind” refers to a motorized window treatment in which the bottom bar or bottom slat of the window treatment is moved upward or downward to raise or lower the slats. In addition, the control circuitry 110 may execute one or more applications, programs, and/or logic sequences to tilt or rotate the slats 103 of the Venetian blind motorized window covering 102 between 0° (i.e., parallel to the window 104), 90° (i.e., perpendicular to the window 104), and 180° (i.e., parallel to the window 104) based on the geolocation, compass heading, date, time-of-day, and weather data received via the weather data API 120.

The control circuitry 110 may include any number and/or combination of electronic components, semiconductor devices, optical elements, quantum elements, and/or logic elements capable of reading one or more machine-readable instruction sets such as programs, applications, and or logic to receive weather information and/or data via an weather data API 120 and execute one or more algorithms to determine the position and/or tilt/rotation for one or more communicatively coupled motorized window coverings 102 using at least the received weather data. In addition, the control circuitry 110 may also execute one or more algorithms to determine the position and/or tilt/rotation for one or more communicatively coupled motorized window coverings 102 using at least data representative of the geolocation of the window 104, the compass heading of the window 104, the date, and the time-of-day. In embodiments, the control circuitry 110 may adjust the position and/or rotation/tilt of the motorized window covering 102 on a periodic, aperiodic, regular, irregular, continuous, intermittent, and/or event driven basis. In at least some implementations, the control circuitry 110 may initiate a count-down timer responsive to positioning and/or rotating/tilting the motorized window covering 102. In such implementations, the control circuitry 110 may wait for the count-down timer to time out prior to once again positioning and/or rotating/tilting the motorized window covering 102. Such a delay minimizes the distraction caused by the movement of the motorized window covering 102 to the occupants present in the space 106.

In embodiments, the control circuitry 110 may be collocated or disposed at least partially within the motorized window covering 102, for example within the headrail of the motorized window covering 102. In other embodiments, the control circuitry 110 may include a system control circuitry capable of controlling one or more motorized window coverings 102 and receiving information and/or data from one or more sensors 108, such as one or more occupancy/vacancy sensors, one or more daylight sensors, etc. In at least some implementations, the control circuitry 110 may additionally include one or more communications interface circuits 140A-140n (only one depicted in FIG. 1) and one or more memory circuits 130A-130n (only one depicted in FIG. 1). The control circuitry 110 may include at least one processor, single-or multi-core microprocessor, field programmable gate array (FPGA), application specific integrated circuits (ASIC), digital signal processors (DSP), system-on-a-chip (SOC), reduced instruction set computers (RISC), or combinations thereof. In embodiments, the components forming the control circuitry 110 may be disposed in each motorized window covering 102. In other embodiments, the components forming the control circuitry 110 may be equally or unequally shared, allocated, or apportioned between or among two or more motorized window coverings.

The control circuitry 110 executes one or more weather data APIs 120 to receive weather-related information and/or data from one or more weather data providers 150. Such weather-related information may include current local environmental conditions that may include but are not limited to temperature, pressure, humidity, precipitation, cloud cover, or combinations thereof. Such weather-related information may include short-term (e.g., 30 minutes, 60 minutes, 2 hours, 4 hours, 6 hours, 12 hours, 24 hours) forecasted or predicted local environmental conditions. The weather data providers 150 may include one or more local or network-based weather data providers such as The Weather Channel® (https://weather.com/), The Weather Company® (https://www.ibm.com/weather), WeatherBELL Analytics® (https://www.weatherbell.com/), Baron (https://www.baronweather.com/), and AccuWeather® (https://www.accuweather.com/). The control circuitry 110 may receive weather-related information via the weather data API 120 at regular or irregular intervals; at periodic or aperiodic intervals; on an intermittent basis; on a continuous basis; or on an event-driven basis. In some examples, the control circuitry 110 may pull at least a portion of the weather-related information from the one or more weather data providers 150. In other examples, the weather data providers 150 may push at least a portion of the weather-related information to the control circuitry 110.

The memory circuitry 130 may include any number and/or combination of electrical components, semiconductor devices, optical storage elements, quantum storage elements, and/or logic elements capable of storing or otherwise retaining programs, applications, information, and/or data. At least a portion of the memory circuitry 130 may include transitory memory circuitry 130A where the control circuitry 110 may store program and application related information and/or data. At least a portion of the memory circuitry 130 may include non-transitory memory circuitry 130B to store or otherwise retain information and/or data such as one or more programs, applications, the one or more weather data APIs 120, and similar. In some examples, all or a portion of the memory circuitry 130 may be incorporated into the control circuitry 110, for example as cache memory circuitry communicatively coupled to processor or microprocessor circuitry within the control circuitry. In some examples, all or a portion of the memory circuitry 130 may include fixed or rotating storage media such as one or more optical drives, one or more magnetic storage devices, one or more solid-state memory devices, one or more quantum storage devices, one or more molecular storage devices, or combinations thereof. In some examples, all or a portion of the memory circuitry 130 may include one or more network storage devices such as one or more file servers, one or more cloud-based storage devices, or any combination thereof. In some examples, all or a portion of the memory circuitry 130 may include one or more removable storage devices such as a digital (SD) storage device, a universal serial bus (USB) storage device, a solid-state drive (SSD), or combinations thereof.

The communications interface circuitry 140 includes any number and/or combination of electrical components, semiconductor devices, optical devices, quantum devices, and/or logic elements capable of providing a wireless and/or wired communications interface. In embodiments, the control circuitry 110 may include all or a portion of the communications interface circuitry 140, for example using a SOC construction or a stacked semiconductor package. In embodiments, the communications interface circuitry 140 may include one or more industry standard communications interfaces such as one or more wired or wireless Ethernet (IEEE 802.3 or 802.11) compliant communications interfaces 140. In embodiments, the communications interface circuitry 140 may include one or more communications interfaces using a proprietary communications protocol, such as the ClearConnet protocol, e.g., the ClearConnect A (CCA) protocol, the ClearChannel X (CCX) protocol, or similar protocols as offered by Lutron Electronics Co., Inc. (Coopersburg, PA). The communications interface circuitry 140 may include a first portion using an industry standard communications protocol such as IEEE 802.11 (WiFi®) and a second portion using a proprietary communications protocol such as the CCA or CCX communications protocols.

In at least some examples, the control circuitry 110 may execute one or more algorithms to determine the quantity and angle of incidence of light on the exterior surface of the window 104. In some instances, the control circuitry 110 may perform one or more retrievals or look-up operations using one or more locally or remotely stored data tables, data structures, data stores, or databases to determine the quantity and angle of incidence of light on the exterior surface of the window 104 as a function of the date and time-of-day and/or solar time of day. In other instances, the control circuitry 110 may execute one or more algorithms, logic, or machine-readable instruction sets to determine the quantity and angle of incidence of light on the exterior surface of the window 104 as a function of the date and time-of-day and/or solar time of day. Using the determined quantity and angle of incidence of light on the exterior surface of the window 104 as a function of the date and time-of-day and/or solar time of day, the control circuitry 110 may determine a base position and/or angle of tilt of the motorized window covering 102 to provide a defined level of light and/or sunlight penetration into the space 106.

The control circuit 110 communicatively couples to the weather data provider 150 to receive weather information used to determine the position and/or the rotation/tilt of the motorized window coverings 102. In some examples, the control circuit 110 may pull such weather information from the weather data provider 150 on a periodic, aperiodic, regular, irregular, continuous, intermittent, and/or event driven (e.g., upon receipt of an input requesting weather information) basis. In other examples, the weather data provider 150 may push the weather information to the control circuit 110 on a periodic, aperiodic, regular, irregular, continuous, intermittent, and/or event driven (e.g., upon detection of a change in weather conditions or upon receipt of a severe weather alert) basis. In at least some instances, during severe weather events the control circuit 110 may use such weather information to override a motorized window covering positioning algorithm based on date and time-of-day information. For example, in response to receipt of a “high wind” alert or similar, the control circuit 110 may position the slats 103 at an angle of 0° to reduce the ingress of glass fragments if the window 104 fractures, at least in part, due to a weather-related event.

The amount of light and/or sunlight entering the space 106 is not a static value and although the algorithms executed by the control circuitry 110 may alter, adjust, move, or control the position and angle of rotation/tilt of the motorized window covering 102 compensate for lighting conditions as they vary over the course of a day, such time and position based algorithms fail to take into account the variability of light and/or sunlight due to weather-related conditions such as overcast, fog, and/or precipitation. While the use of light sensors 108 (e.g., daylight sensors) may assist in reactively addressing the reduced light conditions caused by weather-based events, such light sensors 108 are reactive in nature, requiring the event (in this case a weather related event) to occur prior to taking corrective action (such as adjusting the position and/or angle of rotation/tilt) to increase the quantity of ambient light entering the space 106 through the window 104.

The systems and methods disclosed herein beneficially and advantageously improve the operation of such motorized window covering systems by incorporating weather information into the determination of the position and/or angle of tilt/rotation of a motorized window covering 102 by the control circuitry 110. The incorporation of weather-related information beneficially adds a proactive capability to the determination of the position and/or angle of tilt/rotation of a motorized window covering 102 thereby improving the ergonomics and aesthetics within the space 106 by providing a more uniform and predictable level of illumination within the space 106.

In embodiments, the control circuitry 110, using the base position (e.g. of the bottom bar or hem bar) and/or angle of tilt of the slats 103 of the motorized window covering 102, executes one or more algorithms to determine whether to raise or lower the window covering to a final position and/or adjust the angle of tilt of the slats 103 of the motorized window covering 102 to a final tilt angle based on a predicted level of exterior light incident on the window 104. For example, if the weather data received from the weather data provider 150 via the weather data API 120 indicates increasing cloudiness beginning at 1:00 PM local time, the control circuitry 110 may proactively begin altering, adjusting, moving, or controlling the position and/or angle of tilt of the slats 103 of the motorized window covering 102 beginning at 12:50 PM (i.e., 10 minutes early—in a proactive manner) to maintain the desired level of illumination within the space 106 as the available external light is reduced due to the increasing cloudiness at 1:00 PM.

In another example, the control circuitry 110 may execute one or more algorithms to determine the position and/or angle of tilt of the slats 103 of the motorized window covering 102 based on an expected duration of a current and/or predicted weather event. In such embodiments, the control circuitry 110 may reactively and/or proactively position and/or angle of tilt of the slats 103 of the motorized window covering 102 for weather events having an expected duration greater than a threshold value to limit the number of position or angle changes. By limiting such position or angle changes, the control circuitry 110 may minimize the potential distraction such movements may provide to occupants of the room. For example, the control circuitry 110 may reactively and/or proactively adjust the position and/or angle of tilt of the slats 103 of the motorized window covering 102 for weather events that are predicted to exceed: a 5-minute threshold; a 10-minute threshold; a 15-minute threshold; a 30-minute threshold; a 45-minute threshold; or a 60-minute threshold.

To prevent too-frequent changes in the position and/or angle of tilt of the slats 103 of the motorized window covering 102, the control circuitry 110 may implement a change interval timer that provides a defined interval (e.g., 30 minutes) between changes in the position and/or angle of rotation/tilt of the motorized window covering 102. The interval between changes in the position and/or angle of rotation/tilt of the motorized window covering 102 may be manually adjusted upward (e.g., intervals greater than 30 minutes, such as 45 minutes, 60 minutes, 90 minutes, or 120 minutes) or downward (e.g., intervals less than 30 minutes, such as 20 minutes, 10 minutes, or 5 minutes).

The control circuitry 110 may receive one or more inputs that include information indicative of one or more user and/or occupant lighting preferences. For example, an occupant of the space may find the movement of the motorized window covering 102 distracting. In some instances, the occupant may provide an input to the control circuitry 110 that includes information and/or data representative of an increased transition interval between changes in the position and/or angle of tilt of the slats 103 of the motorized window covering 102 (e.g., data representative of a transition interval in excess of 30 minutes). In other instances, an occupant may desire to take full advantage of the ambient light outside of the space and may desire more frequent changes in the position and/or angle of tilt of the slats 103 the motorized window covering 102. In such instances, the occupant may provide an input to the control circuitry 110 that includes information and/or data representative of an decreased transition interval between changes in the position and/or angle of rotation/tilt of the motorized window covering 102 (e.g., data representative of a transition interval shorter than 30 minutes). Such user input may be received, for example, via a wired or wireless control panel communicatively coupled to the control circuitry 110, a portable electronic device such as a smartphone communicatively coupled to the control circuitry 110, and/or a network device communicatively coupled to the control circuitry 110. Competitive systems and methods using a location and time-based positioning of motorized window covering 102, even those with additional sensor-based inputs, are unable to provide such proactive adjustment capability.

The system 100 includes one or more processor-based devices 160A-160n (collectively, “processor-based devices 160”), each of which includes a wired or wireless communication interface capable of communicatively coupling to the communications interface circuitry 140. The one or more processor-based devices 160 may be used to configure one or more operational aspects of the control circuitry 110 and/or the motorized window covering 102. The one or more processor-based devices 160 may be used by the control circuitry 110 to temporally synchronize the system 100 or various components within the system, such as the one or more motorized window coverings 102, with a single timekeeper to provide an accurate time-of-day for determining the base position and/or base angle of tilt of the slats 103 of the motorized window coverings 102 coupled to the control circuitry 110. Setpoints and defined values, such as defined or desired illumination values may be entered or otherwise provided or indicated to the control circuitry 110 using the one or more processor-based devices 160.

The one or more processor-based devices 160 may be used to provide geolocation data, such as a longitude and latitude obtained using the native geolocation capabilities of the processor-based device to the control circuitry 110 for use by the control circuitry 110 in determining the base position and/or angle of rotation of the motorized window covering 102. The one or more processor-based devices 160 may be used to provide data representative of the compass heading of motorized window covering 102, such as a compass direction obtained using the native directional capabilities of the processor-based device to the control circuitry 110 for use by the control circuitry 110 in determining the base position and/or angle of rotation of the motorized window covering 102. In some examples, the one or more processor-based devices 160 may include one or more portable processor-based devices (e.g., notebook computer, ultraportable computer, handheld computer, etc.); one or more wearable processor-based devices (e.g., eyewear, watch, etc.); one or more desktop processor-based devices; one or more server processor-based devices; one or more smartphones; one or more processor-based, handheld or desktop remote control devices; or combinations thereof.

The one or more processor-based devices 160 may communicatively couple to the control circuitry 110 via the communications interface circuitry 140 using an industry standard communication protocol such as an IEEE 802.3 (Ethernet) compliant communication protocol; an IEEE 802.11 (WiFi®) compliant communication protocol; an IEEE 802.15 (Bluetooth®, Near Field Communications) compliant communication protocol; or any other industry standard compliant communication protocol. In some examples, the one or more processor-based devices may communicate with the communications interface circuitry 140 using a proprietary communications protocol, for example a handheld remote device may communicate with the communications interface using an infrared (IR) or radio-frequency (RF) signal and a proprietary communication protocol. In another example, a processor-based device 160 such as a smartphone may execute one or more applications, programs, or logic sequences to enable communication with the communications interface circuitry 140 using a proprietary communications protocol.

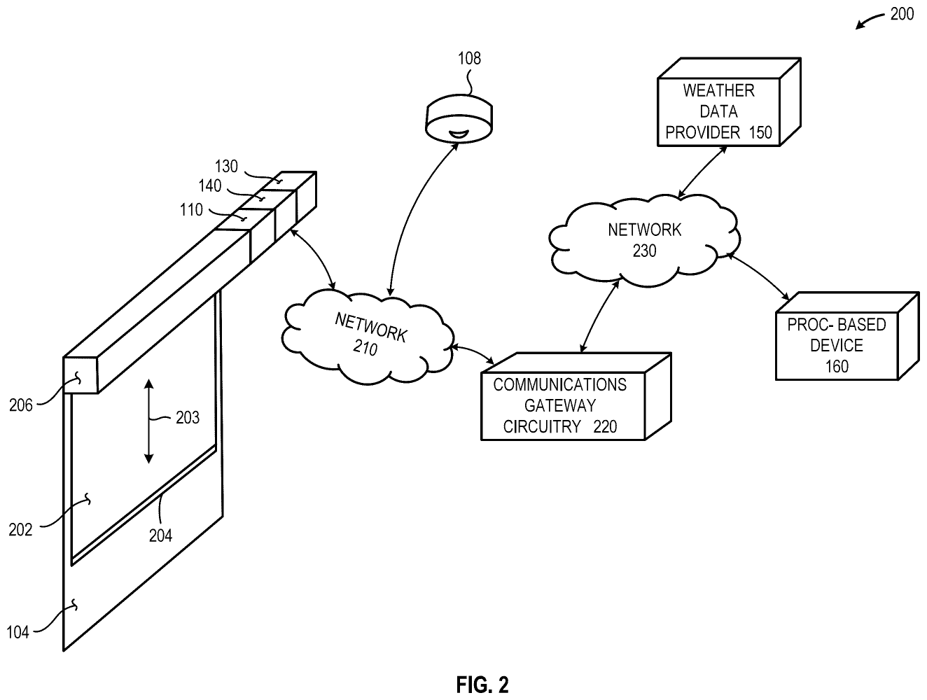

FIG. 2 is a schematic diagram of another illustrative system 200 that includes a roller shade motorized window covering 202 in which the headrail 206 incorporates at least a portion of the control circuitry 110, in accordance with one or more embodiments described herein. As depicted in FIG. 2, the roller shade 202 includes shade material 203 a hembar 204, and the headrail 206. The control circuitry 110 raises/lowers the shade material 203 of the roller shade 202 to produce the desired level of light in the interior space 106. As depicted in FIG. 2, the control circuitry 110 communicatively couples via a first network 210 to communications gateway circuitry 220. The communications gateway circuitry 220 communicatively couples to the weather data provider 150 via a second network 230. In some examples, the control circuitry 110 executes one or more weather data APIs 120 that receive weather-related information from the weather data provider 150 via communications interface circuitry 140, the first network 210, the second network 220, and the communications gateway circuitry 230.

The communications gateway circuitry 220 includes any number and/or combination of electrical components, semiconductor devices, optical elements, quantum elements, and/or logic gates capable of transmitting and receiving information and/or data across the first network 210 and transmitting and receiving information and/or data across the second network 230. In embodiments, information and/or data carried by the first network 210 may use a first communication protocol and information and/or data carried by the second network 230 may use a second communication protocol that differs from the first communication protocol. For example, data and/or information carried across the first network 210 may use a proprietary communication protocol, such as CCA or CCX communications protocols while data and/or information carried across the second network 230 may use an industry standard protocol such as IEEE 802.11. In such embodiments, the communications gateway circuitry 220 provides the capability to reversibly translate between the first network protocol and the second network protocol.

In some examples, the communications gateway circuitry 220 may include one or more system controllers capable of bidirectional communications with any number of motorized window coverings 102A-102n via the first network 210. In other examples, the communications gateway circuitry 220 may include one or more routers or similar bidirectional communications capabilities between the first network 210 and the second network 230.

The first network 210 may include a wired network, a wireless network, or any combination thereof. In at least some embodiments, the first network 210 communicatively couples some or all of the motorized window coverings 102A-102n and some or all of the light sensors 108 disposed in a zone, space, or area of a structure to the communications gateway circuitry 220 and/or to each other. For example, at least a portion of the motorized window coverings 102A-102n and at least a portion of the light sensors 108 may communicatively couple to each other thereby forming the first network 210 as a mesh network in which the communications gateway circuitry represents a node or similar logical structure. Thus, in such a network construct, communications may be routed as “hops” between network devices (i.e., the motorized window coverings 102 and/or the light sensors 108) the source device and a terminal device such as the communications gateway circuitry 220. The second network 230 may include a wired network, a wireless network, or any combination thereof. In some examples, the second network 230 may include one or more: local area networks (LANs); wide area networks (WANs); metropolitan area networks (MANs); wireless local area networks (WLANs); cellular networks (GSM, CDMA, and similar); world-wide networks (WWANs, such as the Internet); or any combination thereof.

The control circuitry 110 executes one or more algorithms to position the height of the roller shade fabric 202 to maintain a desired level of illumination in the space 106. For example, the control circuitry 110 may adjust the height of the roller shade fabric 202 to any height from 0% open (i.e., the roller shade fabric 202 at a lowest position where the roller shade fabric 202 can substantially cover the window) to 100% open (i.e., with the roller shade fabric 202 at a highest position and where the roller shade fabric 202 does not substantially cover the window).

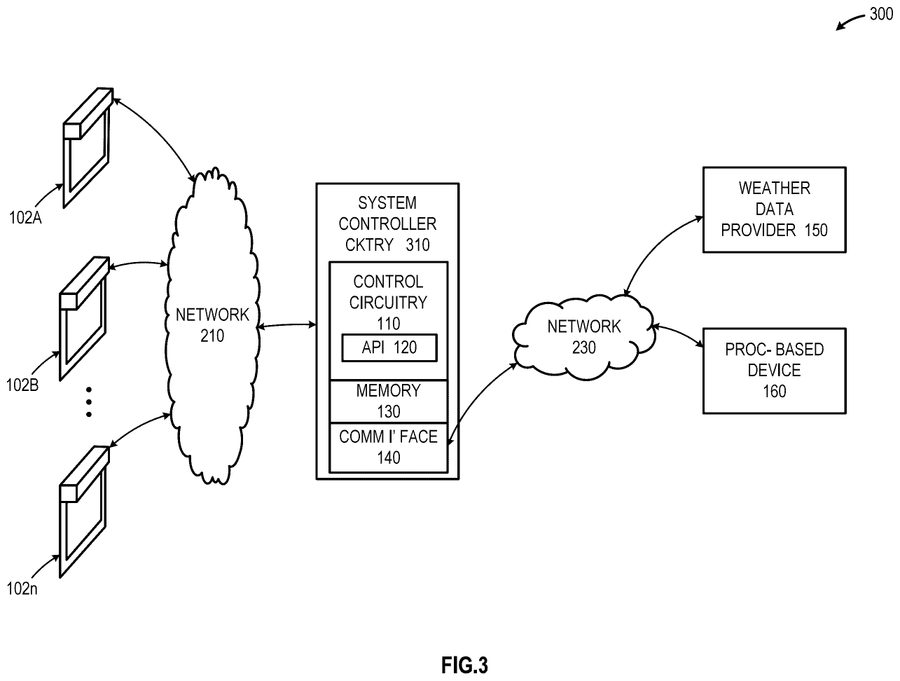

FIG. 3 is a schematic diagram of an illustrative system 300 that includes a plurality of motorized window coverings 102A-102n, each communicatively coupled via a first network 210 to system control circuitry 310 capable of executing the weather data API 120 to receive weather-related information from the weather data provider 150 via a second network 230, in accordance with one or more embodiments described herein. As depicted in FIG. 3, in some examples, the system controller circuitry 310 includes the control circuitry 110 to alter, adjust, move, or control the position and/or angle of rotation/tilt of some or all of the motorized window coverings 102A-102n. In such examples, the system controller circuitry 310 may execute the one or more algorithms to determine the base position and/or angle of tilt of the slats 103 of each of some or all of the motorized window coverings 102A-102n using data representative of some or all of: location, compass heading, date, and time-of-day. In such examples, the system controller circuitry 310 may execute the weather data API to receive weather-related information from the weather data provider 150, and may additionally execute one or more algorithms to determine the final position and/or angle of tilt of the slats 103 for each of some or all of the motorized window coverings 102A-102n using the determined base position and/or angle of tilt of the slats 103 in combination with the received weather-related information. In such examples, the system controller circuitry 310 may communicate, via the first network 210, the data representative of the determined final position and/or angle of tilt of the slats 103 to each of the motorized window coverings 102A-102n.

In other examples, each of some or all of the motorized window coverings 102A-102n may include control circuitry 110 and the system controller circuitry 310 may execute the weather data API 120 to receive the weather-related data from the weather data provider 150. In such examples, the system controller circuitry 310 may communicate via the first network 210 the weather-related data received via the second network 230 from the weather data provider 150 to each of the motorized window coverings 102A-102n. In such examples, each of the individual control circuits 110A-110n in each of the motorized window coverings 102A-102n may determine the base position and/or angle of tilt of the slats 103 of their respective window covering using data representative of some or all of: location, compass heading, date, and time-of-day. In such examples, each of the individual control circuits 110A-110n in each of the motorized window coverings 102A-102n may additionally execute one or more algorithms to determine the final position and/or angle of rotation/tilt of their respective window covering using the determined base position and/or angle of tilt in combination with the received weather-related information. In such examples, each of the control circuits 110A-110n may communicate, via the first network 210, data representative of the determined final position and/or angle of tilt to the system controller circuitry 310.

In some examples, the system controller circuitry 310 may compare the determined final positions and/or angle of tilt of each of some or all of the motorized window coverings 102A-102n to identify motorized window coverings 102A-102n in which the determined final position and/or angle of tilt deviates from an average of the remaining final position and/or angle of tilt of some or all of the remaining motorized window coverings 102A-102n. For example, the system controller circuitry 310 may compare the position and/or angle of tilt of motorized window covering 102A with the average or mean position and/or the average or mean angle of tilt of the remaining motorized window coverings 102B-102n. If the final position of motorized window covering 102A differs by: greater than 5%; greater than 10%; greater than 15%; greater than 20% or greater than 25% from the average or mean position and/or the average or mean angle of rotation/tilt of the remaining motorized window coverings 102B-102n, the system controller circuitry may identify motorized window covering 102A as faulty or otherwise requiring attention to adjust the final position and/or angle of rotation/tilt.

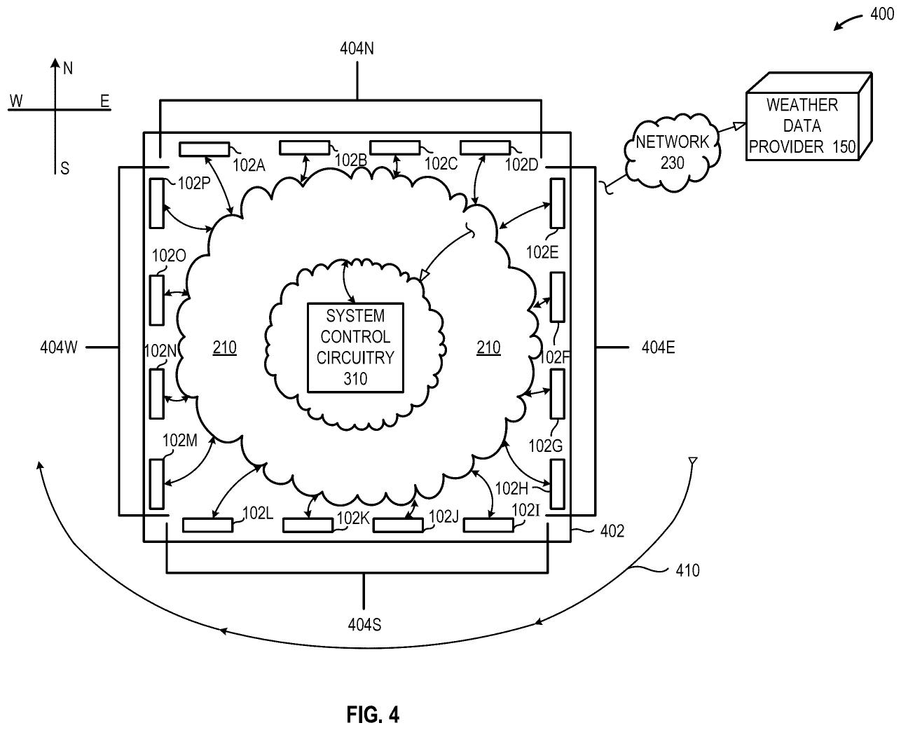

FIG. 4 depicts a plan view of an illustrative system 400 in which system control circuitry 310 autonomously adjusts the position and/or angle of tilt of a plurality of motorized window coverings 102A-102n disposed on a north façade 404N, a south façade 404S, an cast façade 404E, and a west façade 404W of a structure 402 (e.g., according to the corresponding compass headings), using location, compass heading, date, time-of-day, and local weather data, in accordance with one or more embodiments described herein. As depicted in FIG. 4, a solar path 410 (i.e., the path of the sun through the sky) causes direct sunlight to fall on the east façade 404E, the south façade 404S, and the west façade 404W of the structure 402 at various times as the sun traverses the solar path 410. Generally, no direct sunlight falls on the north façade 404N of the structure 402, however reflected (i.e., indirect) sunlight may fall incident on the windows across the north façade 404N of the structure 402.

The second network 230 communicatively couples the system controller circuitry 310 to the weather data provider 150. The weather-related data provided by the weather data provider 150 to the system controller circuitry via the weather data API 120. As depicted in FIG. 4, the system controller circuitry 310 determines the base position and/or the base angle of tilt for all the motorized window coverings 102A-102n as a function of the geolocation (e.g., longitude/latitude) of the structure 402, the compass heading (404N, 404S, 404E, 404W) of the motorized window covering 102, the date, and the time-of-day. The system controller circuitry 310 determines the final position and/or the final angle of tilt for all the motorized window coverings 102A-102n as a function of the geolocation (e.g., longitude/latitude) of the structure 402, the compass heading of the respective façade 404N, 404S, 404E, 404W of the motorized window covering 102, the date, the time-of-day, and the current local weather conditions.

For example, during the morning hours when direct sunlight falls incident on the windows disposed on the cast 404E façade of the structure 402, the system controller circuitry 310 may determine a base position and/or a base angle of tilt for the motorized window coverings 102E-102H along the east façade (404E). The system controller circuitry 310 then determines the final position and/or the final angle of tilt for the motorized window coverings 102E-102H based on the current and/or short-term predicted weather conditions to maintain a desired level of illumination within the structure 402. During the afternoon hours, the system controller circuitry 310 may determine a new base position and/or a new base angle of tilt for the motorized window coverings 102E-102H along the cast façade (404E). The system controller circuitry 310 then determines the final position and/or the final angle of rotation/tilt for the motorized window coverings 102E-102H based on the current and/or short-term predicted weather conditions to maintain the desired level of illumination within the structure 402.

In another example, the system control circuitry 310 provides a “cloudy day override” feature, where the position of the shades/blinds are controlled based on the calculated position of the sun, for example to limit a sunlight penetration into an interior space to defined distance or to completely block direct sun from entering the interior space. As described above, such solar-based window treatment positioning is determined by the system control circuitry using the geolocation of the structure, the orientation of the structure with respect to defined compass heading (404N, 404S, 404E, 404W), the day of year, and the time-of-day. Such solar-based window treatment positioning, however, fails to accommodate the variability of local lighting due to weather, for example, the presence of clouds, cloud density, fog, etc. In such instances, the system control circuitry 310 may beneficially override the solar-based positioning based on local weather conditions received from the weather data provider 150 via network 230. For example, if the received local weather data indicates that it's cloudy, the system control circuitry 310 overrides the solar-based window treatment positioning to open the motorized window treatment thereby permitting more outside light to enter the interior space.

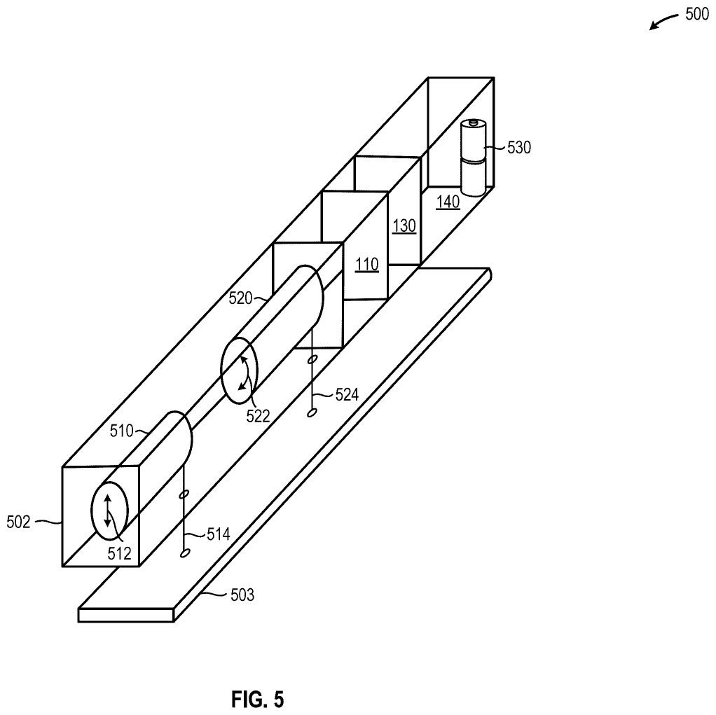

FIG. 5 is a perspective view of an illustrative Venetian blind motorized window covering 500 that includes a headrail 502, a plurality of slats 503A-503n (collectively, “slats 503,” only 1 depicted in FIG. 5 for clarity), a positioning drive or motor 510 that raises and lowers 512 the slats 503 via one or more devices, such as lift cord 514, a tilt drive or motor 520 that tilts 522 the slats 503 at any angle between 0° (vertically outward), 90° (horizontal), and 180° (vertically inward) via one or more devices, such as a tilt ladder 524, in accordance with one or more embodiments described herein. As depicted in FIG. 5, the control circuitry 110, the memory circuitry 130, and the communications interface circuitry 140 may be disposed in the headrail 502 of the Venetian blind motorized window covering 500 along with the positioning drive 510 and the tilt drive 520. In embodiments, the control circuitry 110 may execute the weather data API 120 and may communicate with the weather data provider 150 via one or more networks using one or more routers 220 and/or system controller circuitry 330 communicatively coupled to the Internet.

Responsive to a determination of the final position and final angle of rotation/tilt of the slats 503, the control circuitry 110 generates one or more commands that cause the positioning drive 510 to position the height of the slats (i.e., the portion of the window 104 proximate the slats 503) and cause the rotation/tilt drive 520 to rotate/tilt the slats to a defined angle sufficient to cause a desired, defined, or target illumination within a room, zone, or space within a structure 402 based on the location of the structure, the compass heading of the Venetian blind motorized window covering 500 and the window 104, the date, the time-of-day, and the current and/or short-term forecasted local weather.

The control circuitry 110 may update the final position and/or the final angle of tilt on a periodic basis, an aperiodic basis, a continuous basis, an intermittent basis, a regular basis, an irregular basis, or an event-driven (e.g., a change in local weather conditions) basis. In embodiments, upon positioning and adjusting the angle of the slats 503, the control circuitry 110 may initiate a timer and may prevent any changes in position and/or angle until the timer expires. In some examples, the control circuitry 110 may alter, adjust, move, or change the position and/or angle of tilt of the slats 503 of the Venetian blind motorized window covering 500 at regular intervals of: about once every 5 minutes; about once every 10 minutes; about once every 15 minutes; about once every 20 minutes; about once every 30 minutes; about once every 45 minutes; or about once every 60 minutes. In other examples, the control circuitry 110 may alter, adjust, move, or change the position and/or angle of tilt of the slats 503 of the Venetian blind motorized window covering 500 at random, aperiodic, or irregular intervals. In other examples, the control circuitry 110 may alter, adjust, move, or change the position and/or angle of tilt of the slats 503 of the Venetian blind motorized window covering 500 on an event-driven basis, for example responsive to receipt of a user input to change, adjust, or alter the position and/or angle of tilt of the slats 503.

The headrail 502 may include one or more energy storage devices 530, such as one or more primary (i.e., non-rechargeable) batteries, one or more secondary (i.e., rechargeable) batteries, one or more supercapacitors, one or more ultracapacitors, or any combination thereof. In embodiments, the headrail 502 may additionally or alternatively include one or more power transformers, power converters, or power supplies couplable to an external power sources, such as a power grid. The power supply and/or the energy storage devices included in the headrail 502 may provide power to the control circuitry 110, the memory circuitry 130, and/or the communications interface circuitry 140. In addition, the power supply and/or the energy storage devices included in the headrail 502 may provide power to either or both the positioning drive 510 and/or the tilt drive 520.

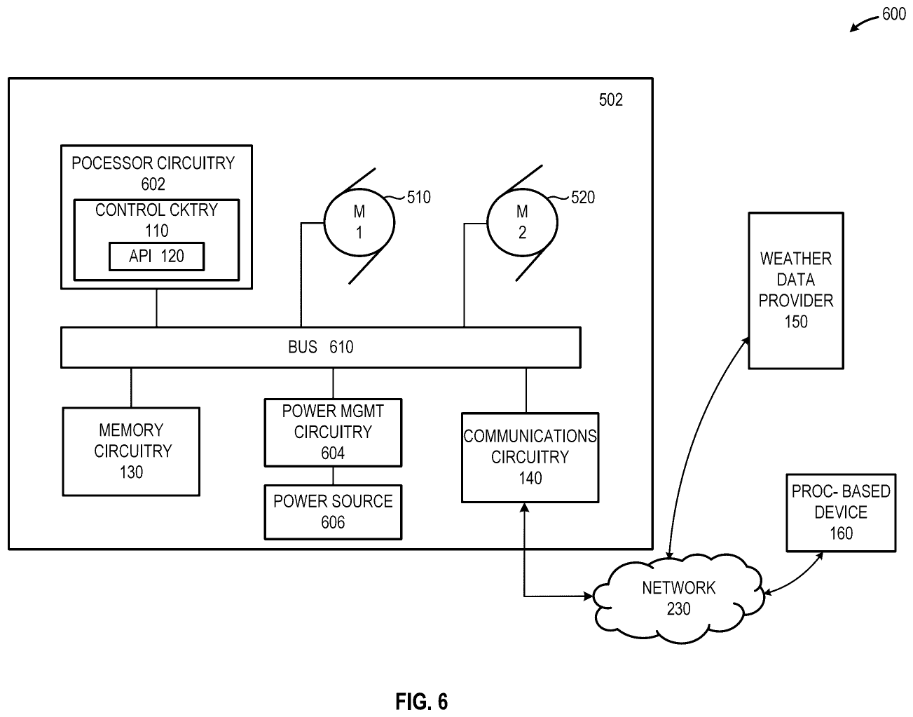

FIG. 6 is a block diagram of an illustrative system 600 that includes a Venetian blind motorized window covering 500 communicatively coupled to a weather data provider 150 via one or more second networks 230, in accordance with one or more embodiments described herein. As depicted in FIG. 6, the Venetian blind motorized window covering 500 may include processor circuitry 602 that provides at least a portion of the control circuitry 110 and which executes the weather data API 120. The Venetian blind motorized window covering 500 may additionally include power management circuitry 604 that provides power 606 to the processor circuitry 602, the memory circuitry 130, the communications interface circuitry 140, the positioning driver 510, and the tilt driver 520. In embodiments, one or more buses 610 may provide bidirectional communications capabilities between the processor circuitry 602, the memory circuitry 130, the communications interface circuitry 140 and the power management circuitry 604. In embodiments, the one or more busses 610 may additionally include one or more power distribution busses that distribute power to the processor circuitry 602, the memory circuitry 130, the communications interface circuitry 140 and the power management circuitry 604, the positioning driver 510 and the tilt driver 520.

Those skilled in the relevant arts can appreciate that the system 600, including the Venetian blind motorized window covering 500, depicted in FIG. 6 may be practiced using other processor-based device configurations, including portable electronic or handheld electronic devices to provide at least a portion of the processor circuitry 602. For example, a portable electronic or handheld electronic device may be used to determine the base or final position and/or the base or final angle of tilt of the motorized window covering and the resultant position and/or angle information communicated to the control circuitry 110. Such portable electronic or handheld electronic devices may include smartphones, portable computers, wearable computers, consumer electronics, personal computers (“PCs”), network PCs, minicomputers, server blades, mainframe computers, and the like. The processor circuit 602 may include any number of hardwired or configurable circuits, some or all of which may include programmable and/or configurable combinations of electrical components, semiconductor devices, optical components, quantum components, and/or logic elements disposed partially or wholly in a cloud-based server or similar computing systems and/or device capable of executing processor-readable instructions.

The processor circuitry 602 may include any number, type, and/or combination of systems, components, networks, or devices capable of executing machine-readable instruction sets. The processor circuitry 602 may include single-or multi-thread cores disposed in one or more central processing units (CPUs). The processor circuitry 602 may include but is not limited to one or more systems-on-a-chip (SOC); central processing unit (CPU); digital signal processor (DSP); graphics processing unit (GPU); application-specific integrated circuit (ASIC); programmable logic controller (PLC); filed programmable gate array (FPGA) and the like. Unless described otherwise, the construction and operation of the various blocks depicted in FIG. 6 are of conventional design. Consequently, such blocks need not be described in greater detail herein, as they will be readily understood by those of ordinary skill in the relevant arts. The one or more busses 610 that interconnect at least some of the components in the Venetian blind motorized window covering 500 may employ any number and/or combination of serial or parallel bus architectures.

The memory circuitry 130 includes one or more of read-only memory (ROM) and random-access memory (RAM). A portion of ROM may be used to store or otherwise retain a basic input/output system (“BIOS”) 344. In some examples, at least some of the one or more machine-readable instruction sets cause at least a portion of the processor circuitry 602 to provide the Venetian blind control circuitry 110 and/or the weather data API 120. The Venetian blind control circuitry 110 may execute one or more machine-readable instruction sets to execute one or more base positioning algorithms to determine the base position of the slats 503 using data representative of the location of the structure 402, the facade 404E, 404W, 404N, and 404S of the structure 402 (e.g., the compass heading), date, and time-of-day. The Venetian blind control circuitry 110 may execute one or more machine-readable instruction sets to execute one or more final positioning algorithms to determine the final position of the slats 503 using data representative of the location of the structure 402, the facade 404E, 404W, 404N, and 404S of the structure 402 (e.g., the compass heading), date, time-of-day, and local current and/or short-term predicted weather data received from the weather data API 120. The Venetian blind control circuitry 110 may execute one or more machine-readable instruction sets to execute one or more base angle of rotation/tilt algorithms to determine the base angle of tilt of the slats 503 using data representative of the location of the structure 402, the facade 404E, 404W, 404N, and 404S of the structure 402 (e.g., the compass heading), date, and time-of-day. The Venetian blind control circuitry 110 may execute one or more machine-readable instruction sets to execute one or more final angle of rotation/tilt algorithms to determine the final angle of rotation/tilt of the slats 503 using data representative of the location of the structure 402, the facade 404E, 404W, 404N, and 404S of the structure 402 (e.g., the compass heading), date, time-of-day, and local current and/or short-term predicted weather data received from the weather data API 120.

The power management circuitry 604 controls one or more operational parameters of the power delivered to at least some components included in the Venetian blind motorized window covering 500. For example, the power management circuitry 604 may include one or more components to convert an alternating-current (AC) voltage from a power source 606 to a reduced-voltage direct-current (DC) voltage used to power the processor circuitry 602. In some examples, the power source 606 may include one or more primary (i.e., non-rechargeable) or secondary (i.e., rechargeable) batteries or combinations thereof. The power source 606 may include one or more supercapacitors or ultracapacitors or combinations thereof. The power management circuitry 604 may alter, adjust, convert, filter, protect, or control the flow of energy from the external power source 606 to at least some components included in the Venetian blind motorized window covering 500. The external power source 606 may include but is not limited to a solar power system, a commercial electric grid, a portable generator, an external energy storage device (e.g., Li-ion energy storage system), or combinations thereof.

For convenience, the processor circuitry 602, the memory circuitry 130, the power management circuitry 604, and the communications interface circuitry 140 are depicted as communicatively coupled via the one or more busses 610, thereby providing communication and power distribution to each component. However, in alternate examples, the above-described components may be communicatively coupled in a different manner or arrangement than depicted in FIG. 6. For example, one or more of the above-described components may be directly coupled another of the above-described components or may be indirectly coupled to another of the above-described components through one or more intermediary components (not depicted in FIG. 3). In another example, one or more of the above-described components may be integrated with the processor circuitry 602. In some embodiments, the one or more busses 610 may be eliminated or reduced and the components interconnected using suitable wired or wireless connections for power distribution and/or communication.

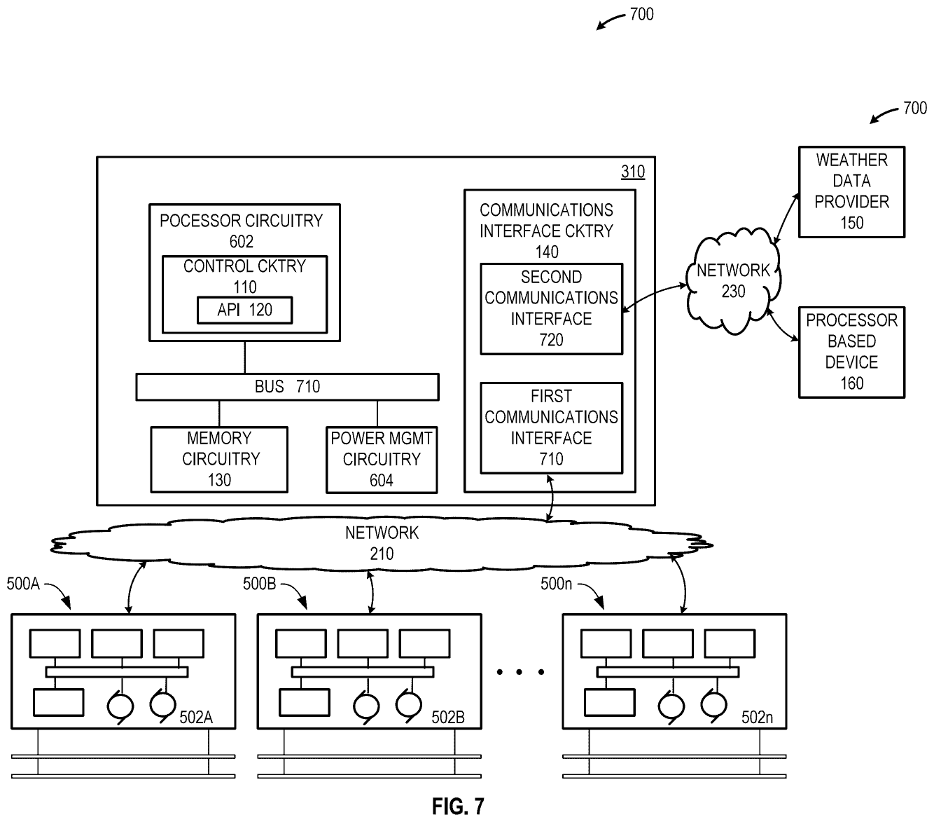

FIG. 7 is a block diagram of an illustrative system 700 in which system controller circuitry 310 alters, adjusts, moves, or controls the position and the angle of rotation/tilt of a plurality of Venetian blind motorized window coverings 500A-500n, in accordance with one or more embodiments described herein. As depicted in FIG. 7, the system control circuitry 310 communicatively couples to the weather data provider 150 via the second network 230. Also as depicted in FIG. 7, the system controller circuitry 310 determines the final position and the final angle of tilt of each of the plurality of Venetian blind motorized window coverings 500A-500n using the location, compass heading, date, time-of-day, and weather-related data received from the weather data provider via the weather data API 120 executed by processor circuitry 602.

The system controller circuitry 310 includes the processor circuitry 602 which provides at least a portion of the control circuitry 110 used to determine the base and final position and the base and final angle of tilt of each of the Venetian blind motorized window coverings 500A-500n operatively and communicatively coupled to the system controller circuitry 310 via at least the first network 210. The system controller 310 includes memory circuitry 130 communicatively coupled to the control circuitry 110 via one or more busses 610. The system controller 310 further includes communications interface circuitry 140 that, in some embodiments, includes first communications interface circuitry 710 and second communications interface circuitry 720. The first communications interface circuitry 710 communicatively couples each of the Venetian blind motorized window coverings 500A-500n to the system controller circuitry 310 via the first network 210. The second communications interface circuitry 720 communicatively couples the weather data provider 150 with the system controller circuitry 310 via one or more second networks 230. The system controller 310 further includes power management circuitry 604 to monitor, adjust, and/or control the power delivered to the control circuitry 110, memory circuitry 130, and communications interface circuitry 140.

Those skilled in the relevant arts can appreciate that the system 700, including some or all of the Venetian blind motorized window covering headrails 502A-502n and/or the system controller circuitry 310, depicted in FIG. 7 may be practiced using other processor-based device configurations, including portable electronic or handheld electronic devices to provide all or a portion of the control circuitry 110A-110n in each of the Venetian blind motorized window coverings 102A-102n and/or all or a portion of the system controller circuitry 310. For example, a portable electronic or handheld electronic device may be used to determine the base or final position and/or the base or final angle of tilt of the motorized window covering and the resultant position and/or angle information communicated to the system controller circuitry 310. Such portable electronic or handheld electronic devices may include smartphones, portable computers, wearable computers, consumer electronics, personal computers (“PCs”), network PCs, minicomputers, server blades, mainframe computers, and the like. The processor circuit 702 may include any number of hardwired or configurable circuits, some or all of which may include programmable and/or configurable combinations of electrical components, semiconductor devices, optical components, quantum components, and/or logic elements disposed partially or wholly in a cloud-based server or similar computing systems and/or device capable of executing processor-readable instructions.

The first communications interface circuitry 710 may include any number and/or combination of electrical components, semiconductor devices, optical components, and/or logic elements capable of communicatively coupling the system controller circuitry 310 to each of at least some of the motorized window coverings 102A-102n disposed in a structure 402. In embodiments, such as depicted in FIG. 7, the first communications interface circuitry 710 may include one or more wired communications interfaces, one or more wireless interfaces, or combinations thereof. The first communications interface circuitry 710 may use an industry standard communications protocol or a proprietary communications protocol to communicate between the system controller circuitry 310 and the motorized window coverings 102A-102n. For example, the first communications interface circuitry 710 may use an industry standard wireless protocol, such as an IEEE 802.11 (e.g., WiFi®) or an IEEE 802.15 (e.g., Bluetooth®) compliant communications protocol to exchange messages, data, information, and/or instructions with at least a portion of the motorized window coverings 102A-102n. In another example, the first communications interface circuitry 710 may use a proprietary wireless protocol, such as Lutron Electronics Co., Inc. (Coopersburg, PA) ClearConnect A (“CCA”) or ClearConnect X communications protocols, to exchange messages, data, information, and/or instructions with at least a portion of the motorized window coverings 102A-102n.

The second communications interface circuitry 720 may include any number and/or combination of electrical components, semiconductor devices, optical components, and/or logic elements capable of communicatively coupling the system controller circuitry 310 to the weather data provider 150 via the second network 230. In embodiments, such as depicted in FIG. 7, the second communications interface circuitry 720 may include one or more wired communications interfaces, one or more wireless interfaces, or combinations thereof. The second communications interface circuitry 720 may use an industry standard communications protocol to communicate between the system controller circuitry 310 and the weather data provider 150. For example, the second communications interface circuitry 720 may use an industry standard communication protocol (e.g., TCP/IP, OSI) to exchange messages, data, information, and/or instructions with the weather data provider 150.

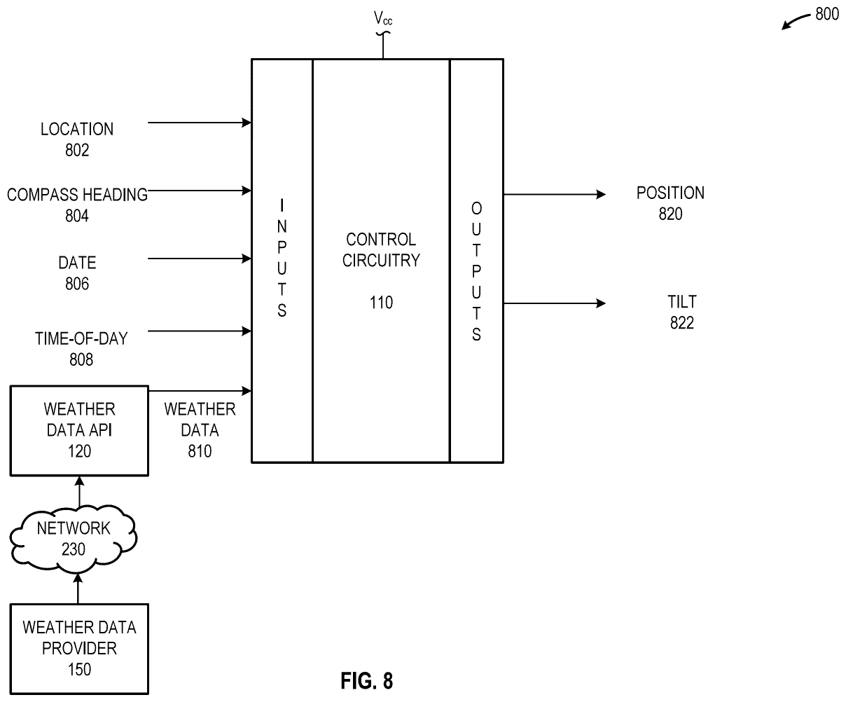

FIG. 8 depicts an input/output diagram 800 of illustrative control circuitry 110 that includes a plurality of inputs 802-810 and a plurality of outputs 820-822, in accordance with one or more embodiments described herein. The inputs to the control circuitry 110 include data representative of the location of the motorized window covering 802, data representative of the compass heading of the motorized window covering 804, data representative of the date 806, data representative of the time-of-day 808, and data representative of the current weather 810. The outputs from the control circuitry 110 include data representative of the final position of the motorized window covering 102 and/or data representative of the final angle of rotation and/or tilt of the motorized window covering 102. The control circuitry 110 executes machine-readable instructions using the inputs 802-810 as data in one or more algorithms to determine one or more outputs that include the final position and/or final angle of rotation/tilt of one or more motorized window coverings 102A-102n.

The data representative of the location of the motorized window coverings 102A-102n may be provided using one or more geolocation systems (GPS, GLONAST, Galileo, etc.) to generate longitude and latitude information and/or data for use in the algorithms executed by the control circuitry 110. In other embodiments, the data representative of the location of the motorized window coverings 102A-102n, may be provided by geolocation circuitry disposed in a portable electronic device, such as a smartphone, when the portable electronic device communicatively couples to the control circuitry 110, for example via the second network 230 and the communications interface circuitry 140. In yet other embodiments, the data representative of the location of the motorized window coverings 102A-102n may be manually entered, placed, written, or disposed in a non-volatile portion of the memory circuitry 130 operatively and communicatively coupled to the control circuitry 110.

The data representative of the compass heading 804 of the motorized window coverings 102A-102n may be provided using one or more directional systems, applications, and/or devices, such as a compass or similar device disposed in, on, or about and communicatively coupled to the control circuitry 110. In embodiments, the data representative of the compass heading 804 of each motorized window covering 102 may be stored in entered, placed, written, stored, or otherwise disposed in a non-volatile portion of the memory circuitry 130 associated with the respective motorized window covering 102. In such embodiments, each of the motorized window coverings 102A-102n may communicate data representative of the compass heading 804A-804n of the respective motorized window covering 102 to the system controller circuitry 310 for use by the control circuitry 110 in determining the final position and/or angle of rotation/tilt of the respective motorized window covering 102. In other embodiments, data representative of the compass heading 804A-804n of each respective one of the motorized window coverings 102A-102n to which the system controller circuitry 310 connects may be stored in one or more data stores, data structures, data tables, or databases stored or otherwise retained in memory circuitry 130 communicatively coupled to the system controller circuitry 310 and/or the control circuitry 110.

The data representative of the date 806 may be provided by clock circuitry included or otherwise disposed in the system controller circuitry 310 and/or the control circuitry 110. In embodiments, the data representative of the date 806 may be provided by clock circuitry disposed in a portable electronic device, such as a smartphone, when the portable electronic device 160 communicatively couples to the system controller circuitry 310 and/or control circuitry 110, for example via the second network 230 and the communications interface circuitry 140.

The data representative of the time-of-day 808 may be provided by real-time clock circuitry included in or otherwise communicatively coupled to the system controller circuitry 310 and/or the control circuitry 110. In embodiments, the data representative of the time-of-day 808 may be provided by clock circuitry disposed in a portable electronic device 160, such as a smartphone, when the portable electronic device 160 communicatively couples to the system controller circuitry 310 and/or control circuitry 110, for example via the second network 230 and the communications interface circuitry 140.

The data representative of the current local weather and/or the short-term local weather forecast weather data provider 150 provides weather data 810 via the weather data API 120. In embodiments, the data representative of the current local weather may include but is not limited to data representative of the current or short-term predicted local temperature, pressure, wind velocity, wind direction, cloud cover, precipitation, humidity (e.g., fog), or combinations thereof. In embodiments, the weather data API 120 may pull the weather related data from the weather data provider on a periodic basis, an aperiodic basis, an intermittent basis, a continuous basis, at regular intervals, at irregular intervals, an event driven basis, or any combination thereof. In embodiments, the weather data provider 150 may push weather-related data to the weather data API 120 on a periodic basis, an aperiodic basis, an intermittent basis, a continuous basis, at regular intervals, at irregular intervals, an event driven basis, or any combination thereof.

The control circuitry 110, using at least a portion of the input data, generates a base position and/or a base angle of tilt for each of the motorized window coverings 102A-102n. Generally, the control circuitry 110 may autonomously generate the same or similar base position and/or base angle of tilt for each of the motorized window coverings 102 that share the same façade 404 of a structure 402. The control circuitry 110 further executes one or more algorithms to alter, adjust, move, reposition, or otherwise control the final position and/or the final angle of tilt of the motorized window coverings 102A-102n using the received weather data. In embodiments, the control circuitry 110 may autonomously generate a desired level of illumination for all or a portion of an interior zone, space, or room 104 within a structure 402 using the date, time-of-day, occupancy of the area, use of the area, or any combination thereof. In other embodiments, the control circuitry 110 may receive, as an input, data representative of a desired level of illumination within the portion of an interior zone, space, or room 104 within a structure 402. For example, the control circuitry 110 may receive an input from a communicatively coupled portable electronic device 160 such as a smartphone. The control circuitry 110 generates a final positioning output signal 820 and/or a final angle of tilt output signal 822 that causes the positioning driver 510 and/or the rotating driver 520 to drive the motorized window covering 102 to a defined configuration to achieve the desired level of illumination in the interior zone, space, or room 104 within a structure 402.

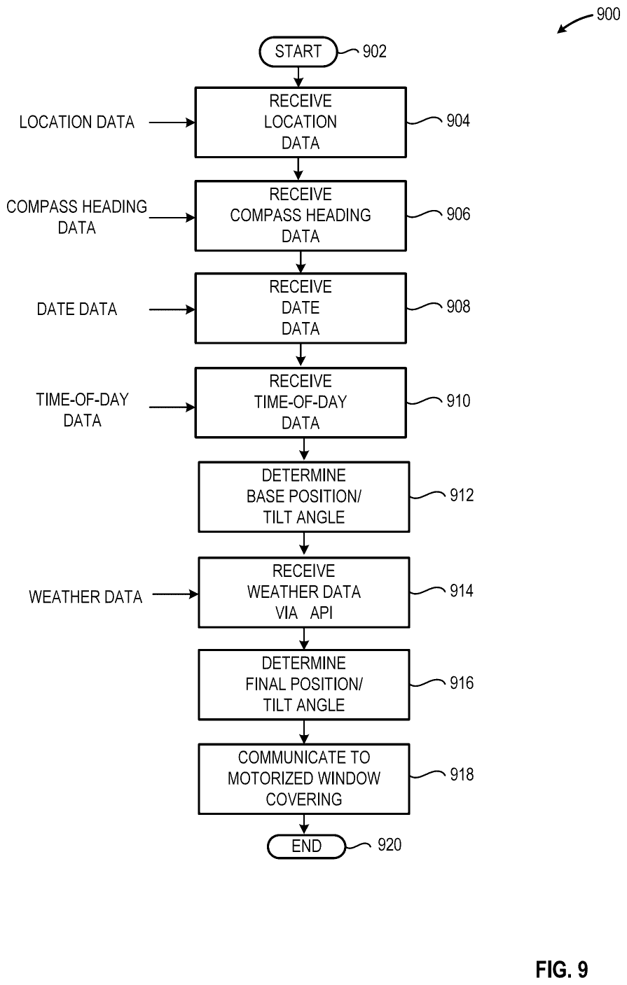

FIG. 9 is a high-level logic flow diagram of an illustrative method 900 of determining a final position and/or a final angle of tilt for one or more motorized window coverings 102 based on the location, the compass heading, the date, the time-of-day, and the local weather conditions proximate each of the motorized window coverings 102A-102n, in accordance with one or more embodiments described herein. The incorporation of weather-related data, obtained via the weather data API 120 executed by the control circuitry 110 beneficially and advantageously permits the adjustment of the base position and/or the base angle of tilt of a motorized window covering 102 based on the impact the local weather conditions, such as cloud cover and fog, may have on achieving a desired level of illumination within an interior space within a structure 402. As disclosed herein, the control circuitry 110 determines a final position and/or a final angle of tilt based on the location of the motorized window covering 102, the compass heading of the motorized window covering 102, the local date, the local time-of-day, and the local weather conditions. Thus, the method 900 provides a distinct improvement over systems that position motorized window coverings using only date and time-of-day algorithms, since such algorithms are unable to consider or reflect a reduction of ambient light levels due to local weather. The method 900 also provides a distinct improvement over systems and methods that position motorized window coverings using date, time-of-day, and measured ambient light (e.g., systems making use of “daylight sensors”) by adding a predictive feature that enables the control circuitry 110 to proactively alter, adjust, change, or move the position and/or angle of tilt based on short-term predicted local weather. The method 900 commences at 902.

At 904, the control circuitry 110 receives information and/or data associated with or representative of the geolocation of a motorized window covering 102. In some examples, the control circuitry 110 may retrieve the geolocation information from one or more data stores, data structures, data tables, or databases stored or otherwise retained in memory circuitry 130 communicatively coupled to the control circuitry 110. In other examples, the control circuitry 110 may retrieve the geolocation information using one or more operatively coupled geolocation circuits, devices, apparatuses, or combinations thereof, such as a global positioning system (GPS) receiver.

At 906, the control circuitry 110 receives information and/or data associated with or representative of the compass heading of a window and/or the motorized window covering 102. In some examples, the control circuitry 110 may retrieve the compass heading information from one or more data stores, data structures, data tables, or databases stored or otherwise retained in memory circuitry 130 communicatively coupled to the control circuitry 110. In other examples, the control circuitry 110 may retrieve the compass heading information using one or more operatively coupled geolocation circuits, devices, apparatuses, or combinations thereof, such as an electronic compass application executing on a processor-based device 160, such as a smartphone, that is communicatively coupled to the control circuitry 110.

At 908, the control circuitry 110 receives information and/or data associated with the current calendar date. The control circuitry 110 may retrieve information indicative of the calendar date from one more real-time clocks or similar systems or circuits forming at least a portion of the headrail processor circuitry 602 and/or the system controller processor circuitry 702 that provides all or a portion of the control circuitry 110. In at least some examples, the control circuitry 110 may confirm and/or synchronize the data representative of the calendar date upon communicatively coupling to a processor-based device 160 such as a smartphone.

At 910, the control circuitry 110 receives information and/or data associated with the current local time-of-day and/or solar time-of-day (e.g., time based on sunrise, sunset, and solar noon). The control circuitry 110 may retrieve information indicative of the current local time-of-day from one more real-time clocks or similar systems or circuits forming at least a portion of the headrail processor circuitry 602 and/or the system controller processor circuitry 702 that provides all or a portion of the control circuitry 110. In at least some examples, the control circuitry 110 may confirm and/or synchronize the data representative of the current local time-of-day upon communicatively coupling to a processor-based device 160 such as a smartphone.

At 912, using one or more first, or base, determination algorithms, the control circuitry 110 determines a base position and/or a base angle of rotation/tilt for the motorized window covering 102. In examples, the control circuitry 110 determines the base position and/or the base angle of rotation/tilt using the data representative of the geolocation of the motorized window covering 102, the data representative of the compass heading of the motorized window covering 102, the data representative of the calendar date, and the data representative of the current time-of-day.

At 914, the control circuitry 110 receives information and/or data associated with the current local weather and/or the predicted short-term local weather via the weather data API 120. The weather data API 120 receives the information and/or data associated with the current local weather and/or the predicted short-term local weather from a weather data provider 150.

At 916, using one or more second, or final, determination algorithms, the control circuitry 110 determines a final position and/or a final angle of rotation/tilt for the motorized window covering 102. In some examples, the control circuitry 110 determines the final position and/or the final angle of rotation/tilt using the data representative of the geolocation of the motorized window covering 102, the data representative of the compass heading of the motorized window covering 102, the data representative of the calendar date, the data representative of the current time-of-day, and the received information associated with the current local weather and/or the predicted short-term local weather.

At 918, using at least a portion of the communicatively coupled communications interface circuitry, the control circuitry 110 communicates the determined final position and/or the determined final angle of rotation/tilt to the motorized window covering 102. In at least some examples, the motorized window covering 102 may store the received data representative of the determined final position and/or the determined final angle of rotation/tilt in communicatively coupled non-transitory memory circuitry such that in the event of a power interruption, the determined final position and/or the determined final angle of rotation/tilt may be retained by the motorized window covering 102. The method 900 concludes at 920.

While FIG. 9 illustrates various operations according to one or more embodiments, it is to be understood that not all of the operations depicted in FIG. 9 are necessary for other embodiments. Indeed, it is fully contemplated herein that in other embodiments of the present disclosure, the operations depicted in FIG. 9, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

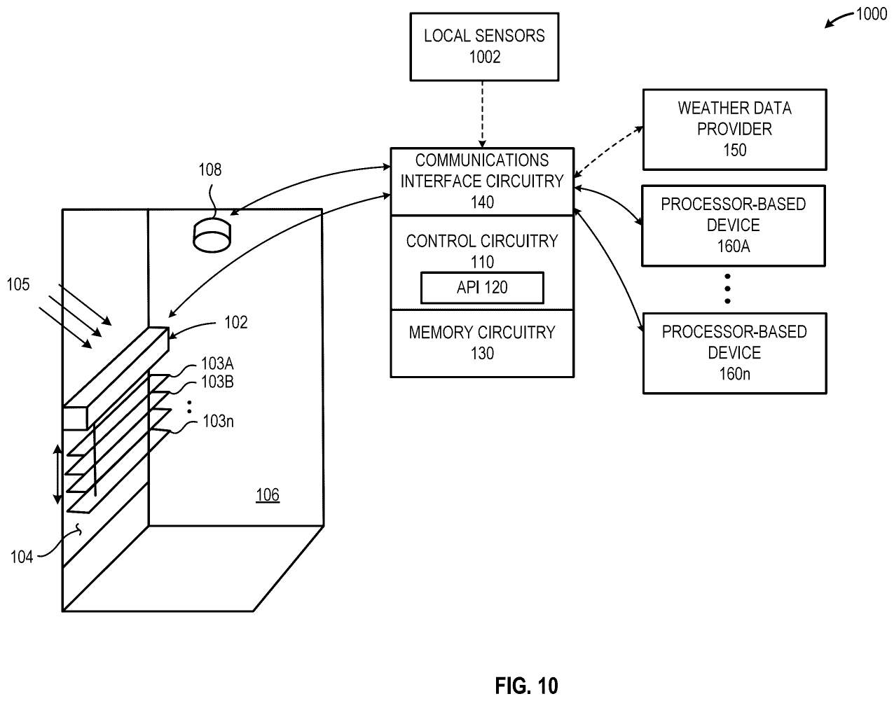

FIG. 10 depicts an illustrative system 1000 that includes a motorized window covering 102 having control circuitry 110 that receives weather related information from one or more sources that include one or more local sensors 1002 and/or via API 120 from a weather data provider 150, in accordance with one or more embodiments described herein. As depicted in FIG. 10, in some implementations, the motorized window covering 102 may include one or more locally mounted sensor(s) 1002, each of which provides one or more output signals that include local weather-related information (temperature, humidity, daylight, etc.) to control circuitry 110. In such embodiments, the control circuitry 110 may be selectively configured to either: receive a short-term predicted weather forecast from the weather data provider 150 via API 120, or generate a short-term predicted weather forecast using weather-related data received from one or more locally mounted sensors 1002 and/or the weather data provider 150. Such locally mounted sensors 1002 can include one or more sensors capable of providing an output signal that includes weather related-data that may include, but is not limited to: temperature, humidity, cloud cover, barometric pressure, wind speed, wind direction, lightning, precipitation intensity, precipitation quantity, and/or solar radiation.

In embodiments, the control circuitry 110 has the capability to determine, forecast, or otherwise predict current and/or short-term local weather conditions using some or all of the weather-related data received from the one or more sensors 1002. In addition, in at least some implementations the control circuitry 110 has the capability to forecast, determine, or otherwise predict the current and/or short-term local weather conditions using some or all of the weather-related data received from the one or more sensors 1002 in conjunction with weather-related data received from the weather data provider 150 via the API 120. In some embodiments, the control circuitry 110 determines such current and/or short-term local weather conditions on a continuous basis. In other embodiments, the control circuitry 110 determines such current and/or short-term local weather conditions on a periodic basis at a defined regular or irregular time interval, such as once every 15 minutes, 30 minutes, 60 minutes, 120 minutes, 240 minutes, 360 minutes, 720minutes, or 1440 minutes. In yet other embodiments, the control circuitry 110 determines such current and/or short-term local weather conditions on an aperiodic basis, for example on an event driven basis such as a change in one or more weather related parameters exceeding a fixed or user-defined threshold value.

In embodiments, the control circuitry 110 can be configured prior to installation to use either (a) weather data provided via API 120 by a weather service provider; or (b) weather-related data provided, at least in part, by one or more local sensors 1002. Such configuration may be performed using a processor-based device, such as a computer, laptop, tablet, or smartphone, that communicatively couples to the control circuitry 110 via the communication interface circuitry 140. In some implementations, the configuration information provided to the control circuitry 110 prior to installation of the motorized window covering 102 may include but is not limited to: the URL of the weather data provider 150; the geolocation of the window 104 where the motorized window covering 102, the compass facing of the motorized window covering 102, or combinations thereof. In such implementations, the control circuitry 110 may access the weather data provider 150 upon installation and connection to an electric load control system having Internet access.

In other implementations, a processor-based device may transfer or otherwise communicate parameters or other information associated with each of the one or more local sensors 1002 prior to installation of the motorized window covering 102. Such parameters may include but are not limited to: sensor type, measured parameter range, measured parameter sensitivity, minimum sensor measurement threshold, maximum sensor measurement threshold, or combinations thereof. In such implementations, the control circuitry 110 may attempt to receive signals from the one or more configured sensors upon installation of the motorized window covering 102 and/or connection of the motorized window covering 102 to an electric load control system. In embodiments, some or all of the one or more local sensors 1002 may be communicatively coupled directly to the control circuitry 110 such that the control circuitry 110 receives the sensor output signal without requiring an intervening device such as an electric load control system controller. In embodiments, some or all of the one or more local sensors 1002 may be communicatively coupled to the control circuitry 110 through one or more intervening devices such as an electric load control system controller via one or more networks. As used herein, the term “local sensor 1002” refers to a sensor disposed proximate the window 104, on a structure that includes the window 104, or within a defined distance (10 feet, 50 feet, 100 feet, 250 feet, 500 feet, 1000 feet, etc.) of the structure that includes the window 104.

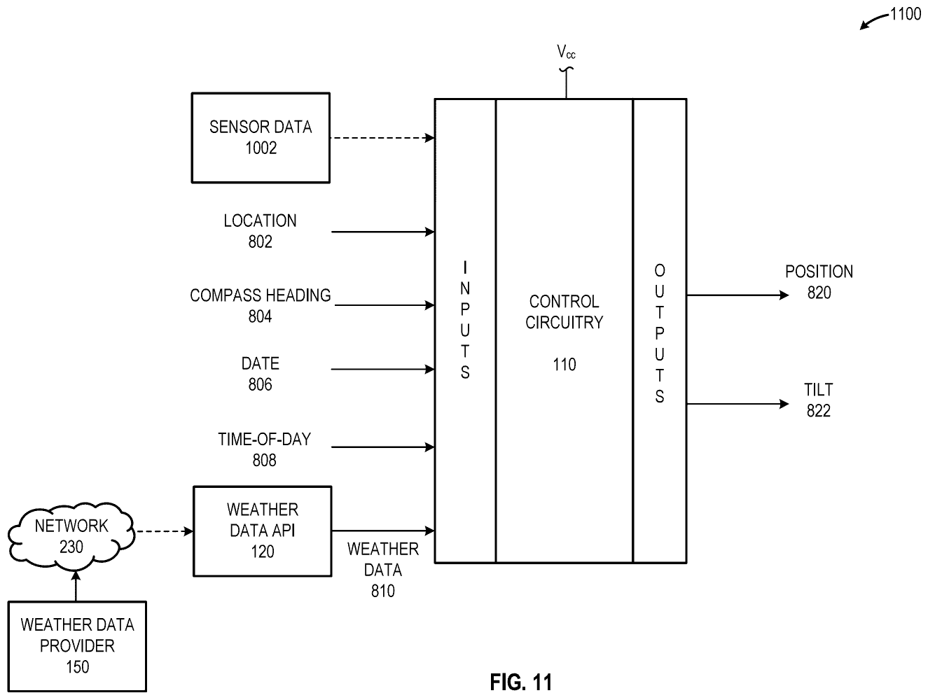

FIG. 11 depicts an input/output diagram of illustrative control circuitry 110 that receives weather related information from one or more sources that include one or more local sensors 1002 and/or via API 120 from a weather data provider 150, in accordance with one or more embodiments described herein. As depicted in FIG. 11, in embodiments, the control circuitry 110 can receive weather related information from one or more local sensors 1002 and/or via an API 120 from a weather data provider 150. In some embodiments, the control circuitry 110 is configured after installation of the motorized window covering 102 proximate window 104. In other embodiments, the control circuitry 110 may be configured prior to installation of the motorized window covering 102 proximate window 104. In such instances, a processor-based device, such as a computer, laptop, tablet, portable computing device, or smartphone, may communicatively couple to the control circuitry 110 and transfer configuration information to the control circuitry 110. In such instances, the control circuitry 110 can cause a storage of the received configuration information in memory circuitry 130. Where weather data is provided by weather data provider 150, illustrative configuration information may include but is not limited to the URL of the weather data provider and user identification and password data to access network resources and/or the weather data provider. In embodiments where one or more sensors provide all or a portion of the weather related data, a processor-based device may transfer or otherwise communicate parameters or other information associated with each of the one or more local sensors 1002 prior to installation of the motorized window covering 102. Such parameters may include but are not limited to: sensor type, measured parameter range, measured parameter sensitivity, minimum sensor measurement threshold, maximum sensor measurement threshold, or combinations thereof.

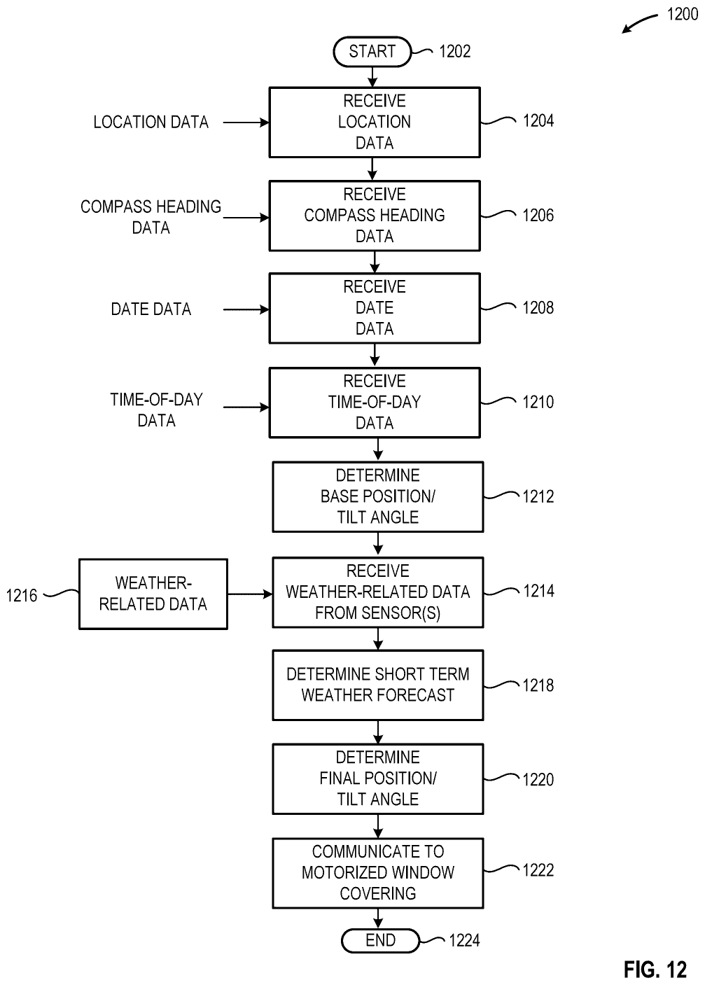

FIG. 12 is a high-level logic flow diagram of an illustrative method 1200 of determining a final position and/or a final angle of tilt for one or more motorized window coverings 102 based on the location, compass heading, date, time-of-day, and a predicted local weather condition determined by the control circuitry 110 using weather related data received from one or more sensors 1002, in accordance with one or more embodiments described herein. Providing the control circuitry 110 with the capability to predict local short term weather using weather data received from one or more sensors 1002 beneficially and advantageously permits the adjustment of the base position and/or the base angle of tilt of a motorized window covering 102 based on the impact the local weather conditions, such as cloud cover and fog, may have on achieving a desired level of illumination within an interior space within a structure 402. As disclosed herein, the control circuitry 110 determines a final position and/or a final angle of tilt based on the location of the motorized window covering 102, the compass heading of the motorized window covering 102, the local date, the local time-of-day, and the predicted short term local weather conditions. Thus, the method 1200 provides a distinct improvement over systems that position motorized window coverings using only date and time-of-day algorithms, since such algorithms are unable to consider or reflect a reduction of ambient light levels due to local weather conditions. The method 1200 also provides a distinct improvement over systems and methods that position motorized window coverings using date, time-of-day, and measured ambient light (e.g., systems making use of “daylight sensors”) by adding a predictive feature that enables the control circuitry 110 to proactively alter, adjust, change, or move the position and/or angle of tilt based on short-term predicted local weather. The method 1200 commences at 1202.

At 1204, the control circuitry 110 receives information and/or data associated with or representative of the geolocation of a motorized window covering 102. In some examples, the control circuitry 110 may retrieve the geolocation information from one or more data stores, data structures, data tables, or databases stored or otherwise retained in memory circuitry 130 communicatively coupled to the control circuitry 110. In other examples, the control circuitry 110 may retrieve the geolocation information using one or more operatively coupled geolocation circuits, devices, apparatuses, or combinations thereof, such as a global positioning system (GPS) receiver.

At 1206, the control circuitry 110 receives information and/or data associated with or representative of the compass heading of a window and/or the motorized window covering 102. In some examples, the control circuitry 110 may retrieve the compass heading information from one or more data stores, data structures, data tables, or databases stored or otherwise retained in memory circuitry 130 communicatively coupled to the control circuitry 110. In other examples, the control circuitry 110 may retrieve the compass heading information using one or more operatively coupled geolocation circuits, devices, apparatuses, or combinations thereof, such as an electronic compass application executing on a processor-based device 160, such as a smartphone, that is communicatively coupled to the control circuitry 110.

At 1208, the control circuitry 110 receives information and/or data associated with the current calendar date. The control circuitry 110 may retrieve information indicative of the calendar date from one more real-time clocks or similar systems or circuits forming at least a portion of the headrail processor circuitry 602 and/or the system controller processor circuitry 702 that provides all or a portion of the control circuitry 110. In at least some examples, the control circuitry 110 may confirm and/or synchronize the data representative of the calendar date upon communicatively coupling to a processor-based device 160 such as a smartphone.

At 1210, the control circuitry 110 receives information and/or data associated with the current local time-of-day and/or solar time-of-day (e.g., time based on sunrise, sunset, and solar noon). The control circuitry 110 may retrieve information indicative of the current local time-of-day from one more real-time clocks or similar systems or circuits forming at least a portion of the headrail processor circuitry 602 and/or the system controller processor circuitry 702 that provides all or a portion of the control circuitry 110. In at least some examples, the control circuitry 110 may confirm and/or synchronize the data representative of the current local time-of-day upon communicatively coupling to a processor-based device 160 such as a smartphone.

At 1212, using one or more first, or base, determination algorithms, the control circuitry 110 determines a base position and/or a base angle of rotation/tilt for the motorized window covering 102. In examples, the control circuitry 110 determines the base position and/or the base angle of rotation/tilt using the data representative of the geolocation of the motorized window covering 102, the data representative of the compass heading of the motorized window covering 102, the data representative of the calendar date, and the data representative of the current time-of-day.

At 1214, the control circuitry 110 receives one or more inputs that include weather related data provided by one or more sensors 1002. The received weather-related data includes but is not limited to data indicative or representative of: temperature, humidity, cloud cover, barometric pressure, wind speed, wind direction, lightning, precipitation intensity, precipitation quantity, and/or solar radiation proximate the window 140 proximate the motorized window covering 102. The one or more sensors 1002 can provide the weather-related data 1216 to the control circuitry 110 on a continuous basis, on a periodic basis, on an aperiodic basis, or an event-driven basis (e.g., responsive to a detected change in a weather-related parameter that exceeds a defined threshold value or places the parameter outside of a predefined range).

At 1218, the control circuitry 110 determines a predicted short-term weather forecast using the weather-related data 1216 received from the one or more sensors 1002 at 1214. For example, the control circuitry 110 may use a change in barometric pressure over time, in conjunction with changes in temperature and relative humidity to determine predict short-term fair or unsettled weather conditions (e.g., increasing barometric pressure typically indicates fair short-term weather while decreasing barometric pressure may be indicative of unsettled weather conditions). In at least some embodiments, the control circuitry 110 may maintain a data store, database, or similar data structure in memory circuitry 130 that correlates, associates, or otherwise relates historical weather parameters to short-term weather. In such instances, the control circuitry 110 may compare the weather-related data received from the one or more sensors 1002 with stored weather data to determine the predicted short-term weather. In other embodiments, the control circuitry 110 may store or otherwise buffer weather-related data received from the one or more sensors 1002 to determine or detect trends in the weather-related data.

At 1220, using one or more second, or final, determination algorithms, the control circuitry 110 determines a final position and/or a final angle of rotation/tilt for the motorized window covering 102. In some examples, the control circuitry 110 determines the final position and/or the final angle of rotation/tilt using the data representative of the geolocation of the motorized window covering 102, the data representative of the compass heading of the motorized window covering 102, the data representative of the calendar date, the data representative of the current time- of-day, and the determined short term local weather prediction.

At 1222, using at least a portion of the communicatively coupled communications interface circuitry, the control circuitry 110 communicates the determined final position and/or the determined final angle of rotation/tilt to the motorized window covering 102. In at least some examples, the motorized window covering 102 may store the received data representative of the determined final position and/or the determined final angle of rotation/tilt in communicatively coupled non-transitory memory circuitry such that in the event of a power interruption, the determined final position and/or the determined final angle of rotation/tilt may be retained by the motorized window covering 102. The method 1200 concludes at 1224.

While FIG. 12 illustrates various operations according to one or more embodiments, it is to be understood that not all of the operations depicted in FIG. 12 are necessary for other embodiments. Indeed, it is fully contemplated herein that in other embodiments of the present disclosure, the operations depicted in FIG. 12, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices.

As used in any embodiment herein, the term “circuitry” may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to the autonomous positioning of motorized window coverings to provide a desired level of illumination in the interior space of a structure. Control circuitry determines a base position and/or a base angle of rotation/tilt using data representative of the geolocation and compass heading of the motorized window covering, the calendar date, and the time of day. Using a weather data API, the control circuitry receives data representative of current local weather and/or current predicted short-term local weather. The control circuitry determines a final position and/or a final angle of rotation/tilt to provide the desired level of illumination in the interior space of the structure using the geolocation and compass heading of the motorized window covering, the calendar date, the time of day, and the received weather data.

The following examples pertain to further embodiments. The following examples of the present disclosure may comprise subject material such as at least one device, a method, at least one machine-readable medium for autonomously determining, by control circuitry, the final position and/or the final angle of rotation/tilt of a motorized window covering to provide a desired level of illumination in an interior space of a structure using geolocation and compass heading of a motorized window covering, a calendar date, a time of day, and received weather data.

According to example 1, there is provided a motorized window covering controller. The motorized window covering controller may include: control circuitry to: execute a weather data application programming interface (API) to transfer local weather-related data from a weather data provider; receive at least one input that includes data representative of a desired level of illumination within a space; receive, via the API, the transferred local weather data from the weather data provider; and determine at least one of: a final position and a final angle of rotation of at least one motorized window covering to provide the desired level of illumination within the space using the received local weather-related data.

Example 2 may include elements of example 1 and the control circuitry may further: receive data representative of a geolocation associated with the at least one motorized window covering; receive data representative of a compass heading associated with the at least one motorized window covering; receive data representative of a current calendar date; receive data representative of a current time-of-day; determine at least one of: a base position and a base angle of rotation of the motorized window covering to provide the desired level of illumination within the space using: the received data representative of the geolocation of the at least one motorized window covering; the received data representative of the compass heading of the at least one motorized window covering; the received data representative of the current calendar date; and the received data representative of the current time-of-day.

Example 3 may include elements of any of examples 1 and 2 where to determine at least one of: a final position and a final angle of rotation of the at least one motorized window covering, the control circuitry may further: determine the at least one of: the final position and the final angle of rotation of the at least one motorized window covering using: at least one of: the base position and the base angle of rotation of the at least one motorized window covering; and the received local weather-related data.

Example 4 may include elements of any of examples 1 through 3 where to determine at least one of: the final position and the final angle of rotation of the at least one motorized window covering, the control circuitry may further: determine at least one of: the final position and the final angle of rotation of the at least one motorized window covering using: the received data representative of the geolocation of the at least one motorized window covering; the received data representative of the compass heading of the at least one motorized window covering; the received data representative of the current calendar date; and the received data representative of the current time-of-day; and the received local weather-related data.

Example 5 may include elements of any of examples 1 through 4 where to receive the local weather-related data from the weather data provider via the weather data API, the control circuitry may further: receive predicted short-term local weather data from the weather data provider via the weather data API.

Example 6 may include elements of any of examples 1 through 5 and the control circuitry may further: autonomously determine, using the received predicted short-term local weather data, at least one of: a proactive final position and a proactive final angle of rotation/tilt of the at least one motorized window covering.

Example 7 may include elements of any of examples 1 through 6 where to autonomously determine, using the received predicted short-term local weather data, at least one of: the proactive final position and the proactive final angle of rotation/tilt of the at least one motorized window covering the control circuitry may further: proactively, autonomously, determine at least one of: the proactive final position and the proactive final angle of rotation/tilt of the at least one motorized window covering; wherein the received predicted short-term local weather data includes at least one of: a relative humidity and a cloud cover.

Example 8 may include elements of any of examples 1 through 7 where to receive local weather-related data via the weather data API, the control circuitry may further: receive current local weather condition data from the weather data provider via the weather data API.

Example 9 may include elements of any of examples 1 through 8 where to receive current local weather condition data from the weather data provider via the weather data API, the control circuitry may further: receive the current local weather condition data including at least one of: a relative humidity and a cloud cover from the weather data provider via the weather data API.

According to example 10, there is provided a motorized window covering control method. The method may include: executing, by control circuitry, a weather data application programming interface (API) to transfer local weather-related data from a weather data provider; receiving, by the control circuitry, at least one input that includes data representative of a desired level of illumination within a space; receiving, by the control circuitry, the local weather-related data from the weather data provider via the API; and determining, by the control circuitry, at least one of: a final position and a final angle of rotation of at least one motorized window covering to provide the desired level of illumination within the space using the received local weather-related data.

Example 11 may include elements of example 10 and the method may further include: receiving, by the control circuitry, data representative of a geolocation associated with the at least one motorized window covering; receiving, by the control circuitry, data representative of a compass heading associated with the at least one motorized window covering; receiving, by the control circuitry, data representative of a current calendar date; receiving, by the control circuitry, data representative of a current time-of-day; determining, by the control circuitry, at least one of: a base position and a base angle of rotation of the motorized window covering to provide the desired level of illumination within the space using: the received data representative of the geolocation of the at least one motorized window covering; the received data representative of the compass heading of the at least one motorized window covering; the received data representative of the current calendar date; and the received data representative of the current time-of-day.

Example 12 may include elements of any of examples 10 and 11 where determining at least one of: the final position and the final angle of rotation of the at least one motorized window covering, the control circuitry may further: determining, by the control circuitry, at least one of: the final position and the final angle of rotation of the at least one motorized window covering using: at least one of the base position and the base angle of rotation of the at least one motorized window covering; and the received local weather-related data.

Example 13 may include elements of any of examples 10 through 12 where determining the at least one of: the final position and the final angle of rotation of the at least one motorized window covering, may further include: determining, by the control circuitry, at least one of: the final position and the final angle of rotation of the at least one motorized window covering using: the received data representative of the geolocation of the at least one motorized window covering; the received data representative of the compass heading of the at least one motorized window covering; the received data representative of the current calendar date; and the received data representative of the current time-of-day; and the received local weather-related data.

Example 14 may include elements of any of examples 10 through 13 where receiving the local weather-related data from the weather data provider via the weather data API may further include: receiving, by the control circuitry, predicted short-term local weather data via the weather data API.

Example 15 may include elements of any of examples 10 through 14 and the method may further include: autonomously determining, by the control circuitry using the received predicted short-term local weather data, at least one of: a proactive final position and a proactive final angle of rotation/tilt of the at least one motorized window covering.

Example 16 may include elements of any of examples 10 through 15 where autonomously determining, by the control circuitry using the received predicted short-term local weather data, at least one of: the proactive final position and the proactive final angle of rotation/tilt of the at least one motorized window covering may further include: proactively, autonomously, determining, by the control circuitry, at least one of: the proactive final position and the proactive final angle of rotation/tilt of the at least one motorized window covering; wherein the received data representative of a predicted short-term local weather includes at least one of: a relative humidity and a cloud cover.

Example 17 may include elements of any of examples 10 through 16 where receiving the local weather-related data from the weather data provider via the weather data API may further include: receiving, by the control circuitry, current local weather condition data via the weather data API.

Example 18 may include elements of any of examples 10 through 17 where receiving current local weather condition data via the weather data API may further include: receiving, by the control circuitry, current local weather condition data including at least one of: a relative humidity and a cloud cover via the weather data API.

According to example 19, there is provided a non-transitory, machine-readable, storage device that includes machine-readable instructions that, when executed by motorized window covering control circuitry, may cause the control circuitry to: execute a weather data application programming interface (API) to transfer local weather-related data from a weather data provider; receive at least one input that includes data representative of a desired level of illumination within a space; receive the local weather-related data from the weather data provider via the weather data API; and determine at least one of: a final position and a final angle of rotation of at least one motorized window covering to provide the desired level of illumination within the space using the received local weather-related data.

Example 20 may include elements of example 19 where the instructions, when executed by the motorized window covering control circuitry, may cause the control circuitry to: receive data representative of a geolocation associated with the at least one motorized window covering; receive data representative of a compass heading associated with the at least one motorized window covering; receive data representative of a current calendar date; receive data representative of a current time-of-day; determine at least one of: a base position and a base angle of rotation of the motorized window covering to provide the desired level of illumination within the space using: the received data representative of the geolocation of the at least one motorized window covering; the received data representative of the compass heading of the at least one motorized window covering; the received data representative of the current calendar date; and the received data representative of the current time-of-day.

Example 21 may include elements of any of examples 19 and 20 where the instructions that cause the motorized window covering control circuitry to determine at least one of: the final position and the final angle of rotation of the at least one motorized window covering, may further cause the control circuitry to: determine at least one of: the final position and the final angle of rotation of the at least one motorized window covering using: at least one of the base position and the base angle of rotation of the at least one motorized window covering; and the received local weather-related data.

Example 22 may include elements of any of examples 19 through 21 where the instructions that cause the motorized window covering control circuitry to determine at least one of: the final position and the final angle of rotation of the at least one motorized window covering, may further cause the control circuitry to: determine at least one of: the final position and the final angle of rotation of the at least one motorized window covering using: the received data representative of the geolocation of the at least one motorized window covering; the received data representative of the compass heading of the at least one motorized window covering; the received data representative of the current calendar date; and the received data representative of the current time-of-day; and the received local weather-related data.

Example 23 may include elements of any of examples 19 through 22 where the instructions that cause the motorized window covering control circuitry to receive the local weather-related data from the weather data provider via the weather data API, may further cause the control circuitry to: receive predicted short-term local weather data from the weather data provider via the weather data API.

Example 24 may include elements of any of examples 19 through 23 where the instructions, when executed by the motorized window covering control circuitry, may further cause the control circuitry to: autonomously determine, using the received predicted short-term local weather data, at least one of: a proactive final position and a proactive final angle of rotation of the at least one motorized window covering.

Example 25 may include elements of any of examples 19 through 24 where the instructions that cause the motorized window covering control circuitry to autonomously determine, using the received predicted short-term local weather data, at least one of: the proactive final position and the proactive final angle of rotation/tilt of the at least one motorized window covering may further cause the control circuitry to: autonomously determine, using the received predicted short-term local weather data, at least one of: the proactive final position and the proactive final angle of rotation of the at least one motorized window covering; wherein the received data representative of a predicted short-term local weather includes at least one of: a relative humidity and a cloud cover.

Example 26 may include elements of any of examples 19 through 25 where the instructions that cause the motorized window covering control circuitry to receive the local weather-related data from the weather data provider via the weather data API may further cause the control circuitry to: receive current local weather condition data from the weather data provider via the weather data API.

Example 27 may include elements of any of examples 19 through 26 where the instructions that cause the motorized window covering control circuitry to receive the current local weather condition data from the weather data provider via the weather data API may further cause the control circuitry to: receive the current local weather condition data from the weather data provider, the current local weather condition data including at least one of: a relative humidity and a cloud cover via the weather data API.

According to example 28, there is provided a motorized window covering controller, that includes control circuitry that may: receive weather-related data from one or more sensors; determine a short-term local weather prediction using the received weather-related sensor data; receive at least one input that includes data representative of a desired level of illumination within a space; and determine, using the short-term local weather prediction, at least one of: a final position of at least one motorized window covering to provide the desired level of illumination within the space; or a final angle of tilt of the at least one motorized window covering to provide the desired level of illumination within the space.

Example 29 may include elements of example 28 where to receive the weather-related data from the one or more sensors, the control circuitry may further: receive, from the one or more sensors, weather-related data that includes data representative of at least one of: local temperature, local humidity, local cloud cover, local barometric pressure, local wind speed, local wind direction, lightning, local precipitation intensity, local precipitation quantity, or local level of solar radiation.

Example 30 may include elements of any of examples 28 and 29 where the control circuitry may further: receive via a weather data API, weather-related data from a weather data provider; and determine the short-term local weather prediction using: the received weather-related sensor data; and the weather-related data received from the weather data provider.

Example 31 may include elements of any of examples 28 through 30 where to receive, via the weather data API, the weather-related data from the weather data provider, the control circuitry to further: receive, from the weather data provider via the weather data API, weather-related data that includes at least one of: local temperature, local humidity, local cloud cover, local barometric pressure, local wind speed, local wind direction, lightning, local precipitation intensity, local precipitation quantity, or local level of solar radiation.

Example 32 may include elements of any of examples 28 through 31 where the control circuitry may further: receive data representative of a geolocation associated with the at least one motorized window covering; receive data representative of a compass heading associated with the at least one motorized window covering; receive data representative of a current calendar date; receive data representative of a current time-of-day; determine at least one of: a base position or a base angle of rotation of the motorized window covering to provide the desired level of illumination within the space using one or more of: the received data representative of the geolocation of the at least one motorized window covering; the received data representative of the compass heading of the at least one motorized window covering; the received data representative of the current calendar date; or the received data representative of the current time-of-day.

Example 33 may include elements of any of examples 28 through 32 where to determine at least one of: a final position or a final angle of rotation of the at least one motorized window covering, the control circuitry may further: determine the at least one of: the final position or the final angle of rotation of the at least one motorized window covering using: the base position and the base angle of rotation of the at least one motorized window covering; and the predicted short-term local weather.

Example 34 may include elements of any of examples 28 through 33 where to determine at least one of: the final position or the final angle of rotation of the at least one motorized window covering, the control circuitry may further: determine at least one of: the final position or the final angle of rotation of the at least one motorized window covering using one or more of: the received data representative of the geolocation of the at least one motorized window covering; the received data representative of the compass heading of the at least one motorized window covering; the received data representative of the current calendar date; the received data representative of the current time-of-day; or the predicted short-term local weather.

Example 35 may include elements of any of examples 28 through 34 where the control circuitry may further autonomously determine, using the predicted short-term local weather, at least one of: a proactive final position of the at least one motorized window covering; or a proactive final angle of rotation/tilt of the at least one motorized window covering.

According to example 36, there is provided a motorized window covering control method. The method may include receiving by window covering control circuitry, weather-related data from one or more sensors; determining by the window covering control circuitry, predicted short-term local weather using the received weather-related sensor data; receiving by the window covering control circuitry, at least one input that includes data representative of a desired level of illumination within a space; and determining by the window covering control circuitry, using the predicted short-term local weather, at least one of: a final position of at least one motorized window covering to provide the desired level of illumination within the space; or a final angle of tilt of the at least one motorized window covering to provide the desired level of illumination within the space.

Example 37 may include elements of example 36 where receiving the weather-related data from the one or more sensors may further include: receiving by the window covering control circuitry from the one or more sensors, weather-related data that includes at least one of: local temperature, local humidity, local cloud cover, local barometric pressure, local wind speed, local wind direction, lightning, local precipitation intensity, local precipitation quantity, or local level of solar radiation.

Example 38 may include elements of any of examples 36 and 37 and the method may further include receiving by the window covering control circuitry via a weather data API, weather-related data from a weather data provider; and determining the predicted short-term local weather using: the received weather-related sensor data; and the weather-related data received from the weather data provider.

Example 39 may include elements of any of examples 36 through 38 where receiving, via the weather data API, the weather-related data from the weather data provider may further include: receiving by the window covering control circuitry via the weather data API, the weather-related data that includes at least one of: local temperature, local humidity, local cloud cover, local barometric pressure, local wind speed, local wind direction, lightning, local precipitation intensity, local precipitation quantity, or local level of solar radiation.

Example 40 may include elements of any of examples 36 through 39 and the method may further include: receiving by the window covering control circuitry, data representative of a geolocation associated with the at least one motorized window covering; receiving by the window covering control circuitry, data representative of a compass heading associated with the at least one motorized window covering; receiving by the window covering control circuitry, data representative of a current calendar date; receiving by the window covering control circuitry, data representative of a current time-of-day; and determining by the window covering control circuitry, at least one of: a base position and a base angle of rotation of the motorized window covering to provide the desired level of illumination within the space using one or more of: the received data representative of the geolocation of the at least one motorized window covering; the received data representative of the compass heading of the at least one motorized window covering; the received data representative of the current calendar date; or the received data representative of the current time-of-day.

Example 41 may include elements of any of examples 36 through 40 where determining at least one of: a final position or a final angle of rotation of the at least one motorized window covering may further include: determining by the window covering control circuitry, at least one of: the final position or the final angle of rotation of the at least one motorized window covering using: the base position and the base angle of rotation of the at least one motorized window covering; and the predicted short-term local weather.

Example 42 may include elements of any of examples 36 through 41 where determining at least one of: the final position or the final angle of rotation of the at least one motorized window covering may further include: determining by the window covering control circuitry, at least one of: the final position of the at least one motorized window covering or the final angle of rotation of the at least one motorized window covering using one or more of: the received data representative of the geolocation of the at least one motorized window covering; the received data representative of the compass heading of the at least one motorized window covering; the received data representative of the current calendar date; the received data representative of the current time-of-day; or the predicted short-term local weather.

Example 43 may include elements of any of example 36 through 42 and the method may further include: autonomously determining by the window covering control circuitry using the predicted short-term local weather, at least one of: a proactive final position of the at least one motorized window covering; or a proactive final angle of rotation/tilt of the at least one motorized window covering.

According to example 44 there is provided a non-transitory, machine-readable, storage device that includes instructions that, when executed by control circuitry disposed in a motorized window covering controller, may cause the control circuitry to: receive weather-related data from one or more sensors; determine a short-term local weather prediction using the received weather-related sensor data; receive at least one input that includes data representative of a desired level of illumination within a space; and determine, using the predicted short-term local weather, at least one of: a final position of at least one motorized window covering to provide the desired level of illumination within the space; or a final angle of tilt of the at least one motorized window covering to provide the desired level of illumination within the space.

Example 45 may include elements of example 44 where the instructions that cause the control circuitry to receive the weather-related data from the one or more sensors may further cause the control circuitry to: receive, from the one or more sensors, weather-related data that includes data representative of at least one of: local temperature, local humidity, local cloud cover, local barometric pressure, local wind speed, local wind direction, lightning, local precipitation intensity, local precipitation quantity, or local level of solar radiation.

Example 46 may include elements of any of examples 44 and 45 where the instructions, when executed by the control circuitry, further cause the control circuitry to: receive, via a weather data API, weather-related data from a weather data provider; and determine the short-term local weather prediction based on: the received weather-related sensor data; and the weather-related data received from the weather data provider.

Example 47 may include elements of any of examples 44 through 46 where the instructions that cause the control circuitry to receive, via the weather data API, the weather-related data from the weather data provider may further cause the control circuitry to receive, from the weather data provider via the weather data API, weather-related data that includes at least one of: local temperature, local humidity, local cloud cover, local barometric pressure, local wind speed, local wind direction, lightning, local precipitation intensity, local precipitation quantity, or local level of solar radiation.

Example 48 may include elements of any of examples 44 through 47 where the instructions, when executed by the control circuitry, may further cause the control circuitry to: receive data representative of a geolocation associated with the at least one motorized window covering; receive data representative of a compass heading associated with the at least one motorized window covering; receive data representative of a current calendar date; receive data representative of a current time-of-day; determine at least one of: a base position or a base angle of rotation of the motorized window covering to provide the desired level of illumination within the space using one or more of: the received data representative of the geolocation of the at least one motorized window covering; the received data representative of the compass heading of the at least one motorized window covering; the received data representative of the current calendar date; or the received data representative of the current time-of-day.

Example 49 may include elements of any of examples 44 through 48 where the instructions that cause the control circuitry to determine at least one of: a final position or a final angle of rotation of the at least one motorized window covering, may further cause the control circuitry to: determine at least one of: the final position or the final angle of rotation of the at least one motorized window covering using: the base position and the base angle of rotation of the at least one motorized window covering; and the predicted short-term local weather.

Example 50 may include elements of any of examples 44 through 49 where the instructions that cause the control circuitry to determine at least one of: the final position or the final angle of rotation of the at least one motorized window covering, further cause the control circuitry to: determine at least one of: the final position or the final angle of rotation of the at least one motorized window covering using one or more of: the received data representative of the geolocation of the at least one motorized window covering; the received data representative of the compass heading of the at least one motorized window covering: the received data representative of the current calendar date; the received data representative of the current time-of-day; or the predicted short-term local weather.

Example 51 may include elements of any of examples 44 through 50 where the instructions, when executed by the control circuitry, further cause the control circuitry to: autonomously determine, using the predicted short-term local weather, at least one of: a proactive final position of the at least one motorized window covering; or a proactive final angle of rotation/tilt of the at least one motorized window covering.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

1. A motorized window covering controller, comprising:
control circuitry to:
execute a weather data application programming interface (API) to transfer local weather-related data from a weather data provider;
receive at least one input that includes data representative of a desired level of illumination within a space;
receive, via the weather data API, the transferred local weather data from the weather data provider; and
determine at least one of: a final position of at least one motorized window covering or a final angle of tilt of the at least one motorized window covering to provide the desired level of illumination within the space using the received local weather-related data.

2. The motorized window covering controller of claim 1, the control circuitry to further:
receive data representative of a geolocation associated with the at least one motorized window covering;
receive data representative of a compass heading associated with the at least one motorized window covering;
receive data representative of a current calendar date;
receive data representative of a current time-of-day; and
determine at least one of: a base position or a base angle of rotation of the motorized window covering to provide the desired level of illumination within the space using at least one of:
the received data representative of the geolocation of the at least one motorized window covering;
the received data representative of the compass heading of the at least one motorized window covering;
the received data representative of the current calendar date; or
the received data representative of the current time-of-day.

3. The motorized window covering controller of claim 2 wherein to determine at least one of: a final position or a final angle of rotation of the at least one motorized window covering, the control circuitry to further:
determine the at least one of: the final position of the at least one motorized window covering or the final angle of rotation of the at least one motorized window covering using:
at least one of: the base position or the base angle of rotation of the at least one motorized window covering; and
the received local weather-related data.

4. The motorized window covering controller of claim 2 wherein to determine at least one of: the final position or the final angle of rotation of the at least one motorized window covering, the control circuitry to further:
determine at least one of: the final position or the final angle of rotation of the at least one motorized window covering using at least one of:
the received data representative of the geolocation of the at least one motorized window covering;
the received data representative of the compass heading of the at least one motorized window covering;
the received data representative of the current calendar date;
the received data representative of the current time-of-day; or
the received local weather-related data.

5. The motorized window covering controller of claim 1 wherein to receive the local weather-related data from the weather data provider via the weather data API, the control circuitry to further:
receive short-term predicted local weather data from the weather data provider via the weather data API.

6. The motorized window covering controller of claim 5, the control circuitry to further:
autonomously determine, using the received short-term predicted local weather data, at least one of:
a proactive final position of the at least one motorized window covering; or
a proactive final angle of rotation of the at least one motorized window covering.

7. The motorized window covering controller of claim 6 wherein to autonomously determine at least one of: the proactive final position or the proactive final angle of rotation of the at least one motorized window covering, the control circuitry to further:
autonomously determine, based on the received short-term predicted local weather data, at least one of: the proactive final position or the proactive final angle of rotation of the at least one motorized window covering;
wherein the received short-term predicted local weather data includes at least one of:
a precited relative humidity value; or
a predicted cloud cover value.

8. The motorized window covering controller of claim 1 wherein to receive local weather-related data via the weather data API, the control circuitry to further:
receive current local weather condition data from the weather data provider via the weather data API.

9. The motorized window covering controller of claim 1 wherein to receive current local weather condition data from the weather data provider via the weather data API, the control circuitry to further:
receive the current local weather condition data including at least one of: a current relative humidity value from the weather data provider via the weather data API or a current cloud cover value from the weather data provider via the weather data API.

10. A motorized window covering control method, comprising:
executing, by control circuitry, a weather data application programming interface (API) to transfer local weather-related data from a weather data provider;
receiving, by the control circuitry, at least one input that includes data representative of a desired level of illumination within a space;
receiving, by the control circuitry, the local weather-related data from the weather data provider via the weather data API; and
determining, by the control circuitry, at least one of: a final position of at least one motorized window covering or a final angle of rotation of the at least one motorized window covering to provide the desired level of illumination within the space using the received local weather-related data.

11. The method of claim 10, the method further comprising:
receiving, by the control circuitry, data representative of a geolocation associated with the at least one motorized window covering;
receiving, by the control circuitry, data representative of a compass heading associated with the at least one motorized window covering;
receiving, by the control circuitry, data representative of a current calendar date;
receiving, by the control circuitry, data representative of a current time-of-day; and
determining, by the control circuitry, at least one of: a base position of the at least one motorized window covering or a base angle of rotation of the motorized window covering to provide the desired level of illumination within the space using at least one of:
the received data representative of the geolocation of the at least one motorized window covering;
the received data representative of the compass heading of the at least one motorized window covering;
the received data representative of the current calendar date; or
the received data representative of the current time-of-day.

12. The method of claim 11 wherein determining at least one of: the final position and the final angle of rotation of the at least one motorized window covering further comprises:
determining, by the control circuitry, at least one of: the final position of the at least one motorized window covering or the final angle of rotation of the at least one motorized window covering using:
at least one of the base position or the base angle of rotation of the at least one motorized window covering; and
the received local weather-related data.

13. The method of claim 11 wherein determining the at least one of: the final position or the final angle of rotation of the at least one motorized window covering further comprises:
determining, by the control circuitry, at least one of: the final position of the at least one motorized window covering or the final angle of rotation of the at least one motorized window covering using at least one of:
the received data representative of the geolocation of the at least one motorized window covering;
the received data representative of the compass heading of the at least one motorized window covering;
the received data representative of the current calendar date;
the received data representative of the current time-of-day; or
the received local weather-related data.

14. The method of claim 10 wherein receiving the local weather-related data from the weather data provider via the weather data API further comprises:
receiving, by the control circuitry, predicted short-term local weather data via the weather data API.

15. The method of claim 14, further comprising:
autonomously determining, by the control circuitry, at least one of:
a proactive final position of the at least one motorized window covering based on the received predicted short-term local weather data; or
a proactive final angle of rotation of the at least one motorized window covering based on the received predicted short-term local weather data.

16. The method of claim 15 wherein autonomously determining, by the control circuitry using the received predicted short-term local weather data, at least one of: the proactive final position of the at least one motorized window covering or the proactive final angle of rotation of the at least one motorized window covering further comprises:
autonomously determining, by the control circuitry using the received predicted short-term local weather, at least one of: the proactive final position or the proactive final angle of rotation of the at least one motorized window covering, wherein the received predicted short-term local weather includes at least one of:
a predicted relative humidity value; or
a predicted cloud cover value.

17. The method of claim 10 wherein receiving the local weather-related data from the weather data provider via the weather data API further comprises:
receiving, by the control circuitry, current local weather condition data via the weather data API.

18. The method of claim 10 wherein to receiving current local weather condition data via the weather data API further comprises:
receiving, by the control circuitry, current local weather condition data including at least one of: a current relative humidity value via the weather data API or a current cloud cover value via the weather data API.

19. A non-transitory, machine-readable, storage device that includes instructions that, when executed by control circuitry disposed in a motorized window covering controller, cause the control circuitry to:
execute a weather data application programming interface (API) to transfer local weather-related data from a weather data provider;
receive at least one input that includes data representative of a desired level of illumination within a space;
receive the local weather-related data from the weather data provider via the weather data API; and
determine at least one of:
a final position of at least one motorized window covering to provide the desired level of illumination within the space using the received local weather-related data; or
a final angle of rotation of the at least one motorized window covering to provide the desired level of illumination within the space using the received local weather-related data.

20. The non-transitory, machine-readable, storage device of claim 19 wherein the instructions, when executed by the motorized window covering control circuitry, cause the control circuitry to:
receive data representative of a geolocation associated with the at least one motorized window covering;
receive data representative of a compass heading associated with the at least one motorized window covering;
receive data representative of a current calendar date;
receive data representative of a current time-of-day; and
determine at least one of: a base position of the at least one motorized window covering or a base angle of rotation of the motorized window covering to provide the desired level of illumination within the space using at least one of:
the received data representative of the geolocation of the at least one motorized window covering;
the received data representative of the compass heading of the at least one motorized window covering;
the received data representative of the current calendar date; or
the received data representative of the current time-of-day.

21. The non-transitory, machine-readable, storage device of claim 20 wherein the instructions that cause the motorized window covering control circuitry to determine at least one of: the final position of the at least one motorized window covering or the final angle of rotation of the at least one motorized window covering, further cause the control circuitry to:
determine at least one of: the final position of the at least one motorized window covering or the final angle of rotation of the at least one motorized window covering using:
at least one of:
the base position of the at least one motorized window covering; or
the base angle of rotation of the at least one motorized window covering; and
the received local weather-related data.

22. The non-transitory, machine-readable, storage device of claim 20 wherein the instructions that cause the motorized window covering control circuitry to determine at least one of: the final position of the at least one motorized window covering or the final angle of rotation of the at least one motorized window covering, further cause the control circuitry to:
determine at least one of: the final position of the at least one motorized window covering or the final angle of rotation of the at least one motorized window covering using at least one of:
the received data representative of the geolocation of the at least one motorized window covering;
the received data representative of the compass heading of the at least one motorized window covering;
the received data representative of the current calendar date;
the received data representative of the current time-of-day; or
the received local weather-related data.

23. The non-transitory, machine-readable, storage device of claim 19 wherein the instructions that cause the motorized window covering control circuitry to receive the local weather-related data from the weather data provider via the weather data API, further cause the control circuitry to:
receive short-term predicted local weather data from the weather data provider via the weather data API.

24. The non-transitory, machine-readable, storage device of claim 23 wherein the instructions, when executed by the motorized window covering control circuitry, further cause the control circuitry to:
autonomously determine, using the received short-term predicted local weather data, at least one of:
a proactive final position of the at least one motorized window covering; or
a proactive final angle of rotation of the at least one motorized window covering.

25. The non-transitory, machine-readable, storage device of claim 24 wherein the instructions that cause the motorized window covering control circuitry to autonomously determine, using the received short-term predicted local weather data, at least one of: the proactive final position or the proactive final angle of rotation of the at least one motorized window covering further cause the control circuitry to:
autonomously determine, using the received short-term predicted local weather, at least one of: the proactive final position or the proactive final angle of rotation of the at least one motorized window covering, wherein the received short-term predicted local weather includes at least one of:
a predicted relative humidity value; or
a predicted cloud cover value.

26. The non-transitory, machine-readable, storage device of claim 19 wherein the instructions that cause the motorized window covering control circuitry to receive the local weather-related data from the weather data provider via the weather data API further cause the control circuitry to:
receive current local weather condition data from the weather data provider via the weather data API.

27. The non-transitory, machine-readable, storage device of claim 19 wherein the instructions that cause the motorized window covering control circuitry to receive the current local weather condition data from the weather data provider via the weather data API further cause the control circuitry to:
receive the current local weather condition data from the weather data provider, the current local weather condition data including at least one of:
a current relative humidity value via the weather data API; or
a current cloud cover value via the weather data API.

28-51. (canceled)
